(19) United States
(12) Patent Application Publication
(10) Pub. No.: US 2019/0324287 A1
(43) Pub. Date: Oct. 24, 2019

(54) EYEGLASSES

(71) Applicant: Roberto CARLON, Venezia (IT)

(72) Inventor: Roberto CARLON, Venezia (IT)

(21) Appl. No.: 16/466,560

(22) PCT Filed: Dec. 6, 2017
(86) PCT No.: PCT/IB2017/057692

§ 371 Date: Jun. 4, 2019

(30) Foreign Application Priority Data
Dec. 7, 2016 (IT) 102016000124201

(51) Int. Cl. G02C 1/02; G02C 1/04; A45C 11/04; G02C 5/00

(52) U.S. Cl. CPC G02C 1/02; G02C 1/04; G02C 5/12; G02C 5/008; G02C 2200/10; A45C 11/04

(57) ABSTRACT

Eyeglasses including lens elements, in particular including a first and a second lens, adapted to be placed in front of the wearer's eyes, and means for supporting the lens elements. The means for supporting the lens elements include metal wire means from which the lens elements are hung.

### TECHNICAL FIELD

This invention relates to eyeglasses.

### BACKGROUND ART

As is known, eyeglasses generally comprise lens elements, specifically including a first and a second lens, which are adapted to be placed in front of the wearer's eyes, and corresponding means for supporting the lens elements.

Generally speaking, the frames used for prior art eyeglasses are made of any of a variety of rigid materials, both plastic and metallic, which, however, are too stiff and make the eyeglass structure excessively heavy, uncomfortable and bothersome for the wearer.

In addition, prior art eyeglasses very often make use of connecting means in the form of screws and adhesives which are used to fix the different components to each other but which, besides requiring an excessive number of materials and components, often lead to problems due to loosening and coming apart and, in the case of screws, even being lost. Also known are eyeglasses of the type known as “rimless”, that is, eyeglasses whose nosepieces and respective sidepieces are connected directly to the lenses. In this case, however, stress is applied directly on the lenses and in many cases the resulting strain can be excessive, eventually leading to the lenses breaking.

Thus, the trade feels the need for eyeglasses with a low risk of breakage. Furthermore, the trade feels the need for eyeglasses with high durability. Furthermore, the trade feels the need for high-strength eyeglasses.

Furthermore, the trade feels the need for eyeglasses whose structure is such as to be able to prevent stress and strain from reaching excessively high levels.

Furthermore, the trade feels the need for eyeglasses whose structure is such as to be able to prevent excessively high stress peaks.

Furthermore, the trade also feels the need for eyeglasses which allow saving on the number of components used to make them.

Furthermore, the trade also feels the need for eyeglasses which allow dispensing with the use of unwanted components.

Furthermore, the trade feels the need for eyeglasses which are particularly light in weight.

Furthermore, the trade feels the need for eyeglasses which are particularly comfortable and easy to wear.

Furthermore, the trade feels the need for eyeglasses which are easy to adapt to the wearer's physical or morphological features.

Furthermore, the trade feels the need for eyeglasses which are quick and easy to assemble.

Furthermore, the trade also feels the need for eyeglasses whose cost of production is limited.

### AIM OF THE INVENTION

This invention therefore proposes a new solution as an alternative to the solutions known up to now and, more specifically, proposes to overcome one or more of the above mentioned drawbacks or problems and/or to meet one or more of the needs felt by the trade and which, in particular, may be inferred from the above.

Provided accordingly are eyeglasses comprising lens elements, in particular comprising a first and a second lens, adapted to be placed in front of the wearer's eyes, and means for supporting the lens elements, characterized in that the means for supporting the lens elements comprise metal wire means from which the lens elements are hung.

The eyeglasses thus obtained are light in weight, flexible and, at the same time, extremely robust.

### BRIEF DESCRIPTION OF THE DRAWINGS

These and other innovative aspects, or specific advantageous embodiments are set out in the appended claims and the technical features are apparent from the detailed description which follows of preferred embodiments, which, however, should be considered purely as non-limiting examples of the disclosure; the description being made with reference to the accompanying drawings, in which:

FIG. 1 is a perspective view from above of a first preferred embodiment of the eyeglasses according to this disclosure;

FIG. 2 is a front perspective view of the first preferred embodiment of the eyeglasses according to this disclosure;

FIG. 3 is a another perspective view from above of the first preferred embodiment of the eyeglasses according to this disclosure;

FIG. 4 is a side perspective view of the first preferred embodiment of the eyeglasses according to this disclosure;

FIG. 5 is a side perspective detail view showing the connection of the sidepiece to the lens support in the first preferred embodiment of the eyeglasses according to this disclosure;

FIG. 6 is a front perspective detail view showing the connection of the sidepiece to the lens support in the first preferred embodiment of the eyeglasses according to this disclosure;

FIGS. 7 to 7P illustrate the steps of a first preferred embodiment of the method for making the first preferred embodiment of the eyeglasses according to this disclosure;

FIG. 8 is a front view of a second preferred embodiment of the eyeglasses according to this disclosure;

FIG. 9 is a schematic front perspective view of a third preferred embodiment of the eyeglasses according to this disclosure in the open condition;

FIG. 10 is a schematic front perspective view of the third preferred embodiment of the eyeglasses according to this disclosure in the closed condition;

FIG. 11 is a schematic perspective view from above of the third preferred embodiment of the eyeglasses according to this disclosure in the open condition;

FIG. 12 is a schematic cross section, through line XII-XII of FIG. 9, of the third preferred embodiment of the eyeglasses according to this disclosure;

FIG. 13 is a schematic front elevation of an enlarged detail showing the respective lens of the third preferred embodiment of the eyeglasses according to this disclosure;

FIG. 14 is a schematic perspective view of a fourth preferred embodiment of the eyeglasses according to this disclosure;

FIG. 15 is a schematic perspective view from above of the fourth preferred embodiment of the eyeglasses according to this disclosure;

FIG. 16 is a schematic perspective view of a preferred embodiment of an eyeglass case according to this disclosure, in the open condition;

FIG. 17 is a schematic perspective view of the preferred embodiment of the eyeglass case according to this disclosure, in the open condition, during a step of fastening the eyeglasses to the case;

FIG. 18 is a schematic perspective view of the preferred embodiment of the eyeglass case according to this disclosure, in the open condition, with the eyeglasses fastened to the case;

FIG. 19 is a schematic perspective view of a preferred embodiment of the eyeglass case according to this disclosure, in the closed condition.

### DETAILED DESCRIPTION OF PREFERRED EMBODIMENTS OF THE INVENTION

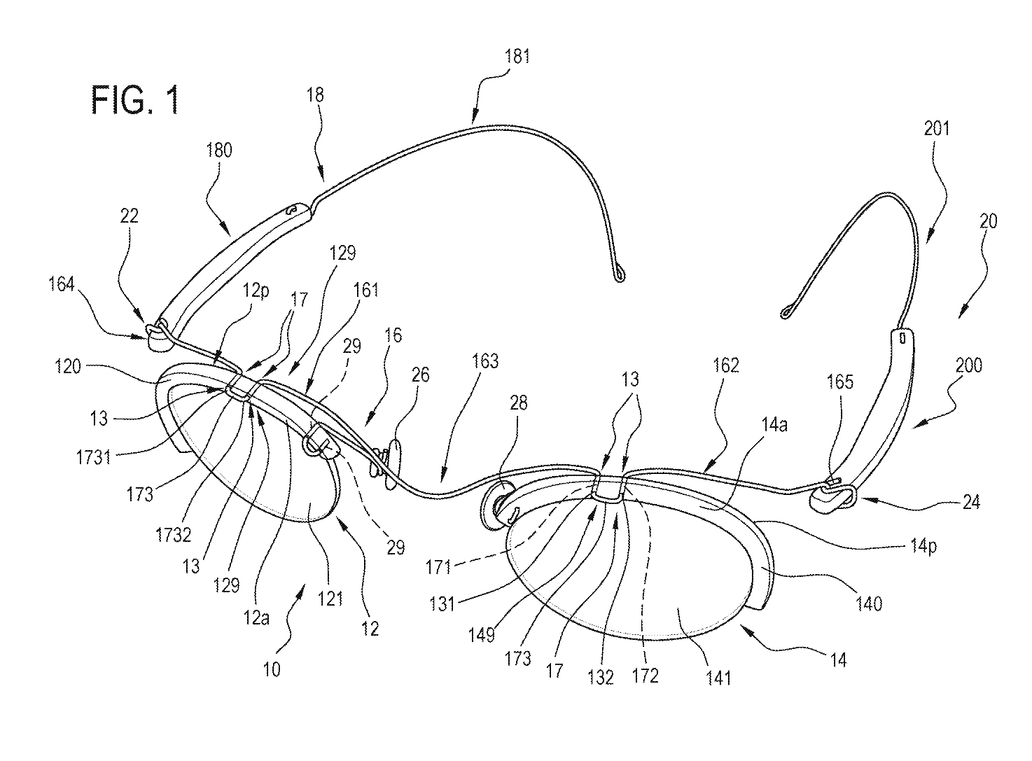

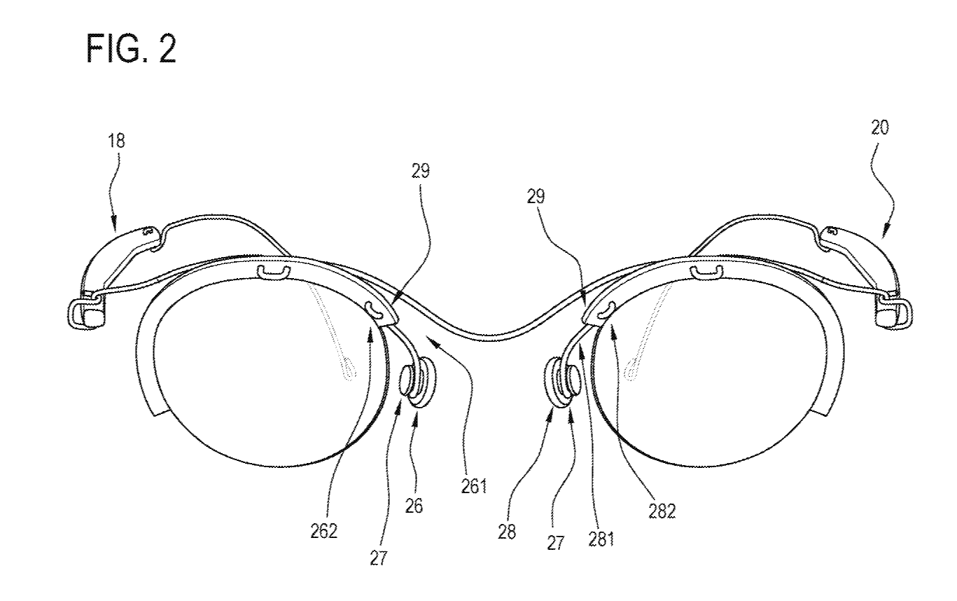

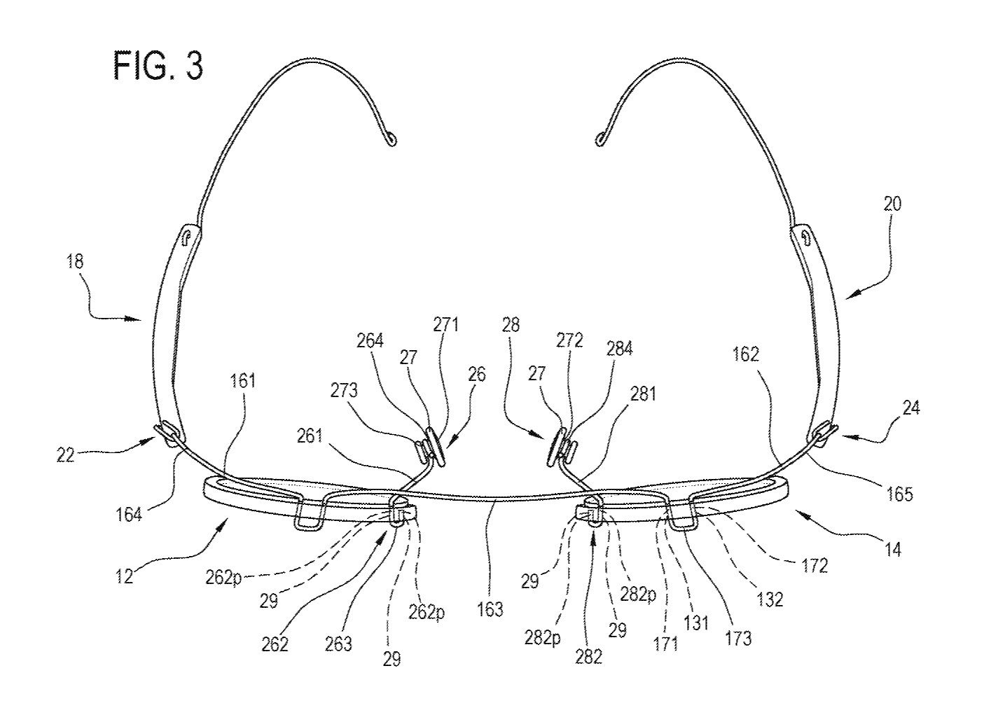

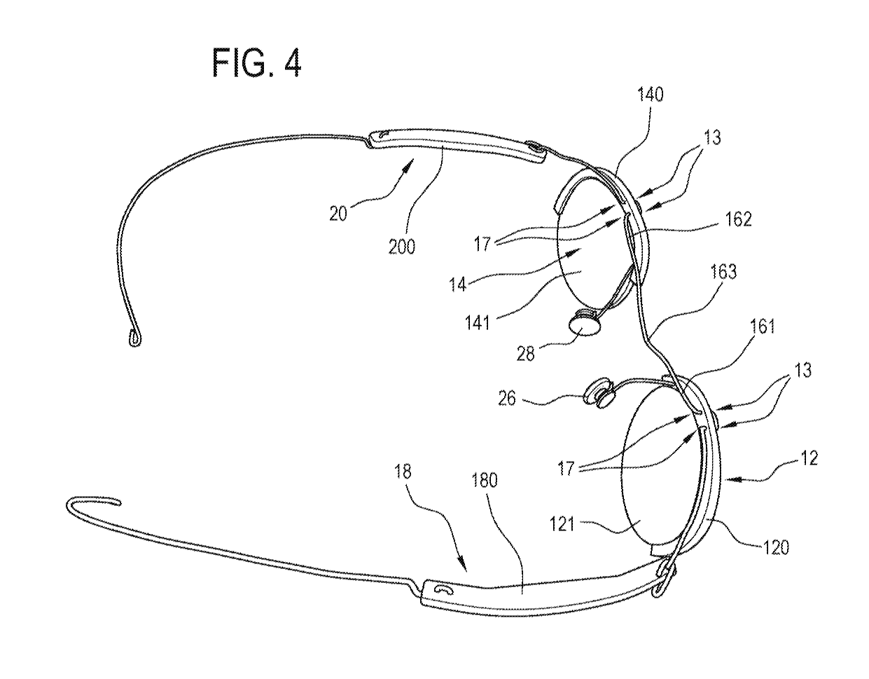

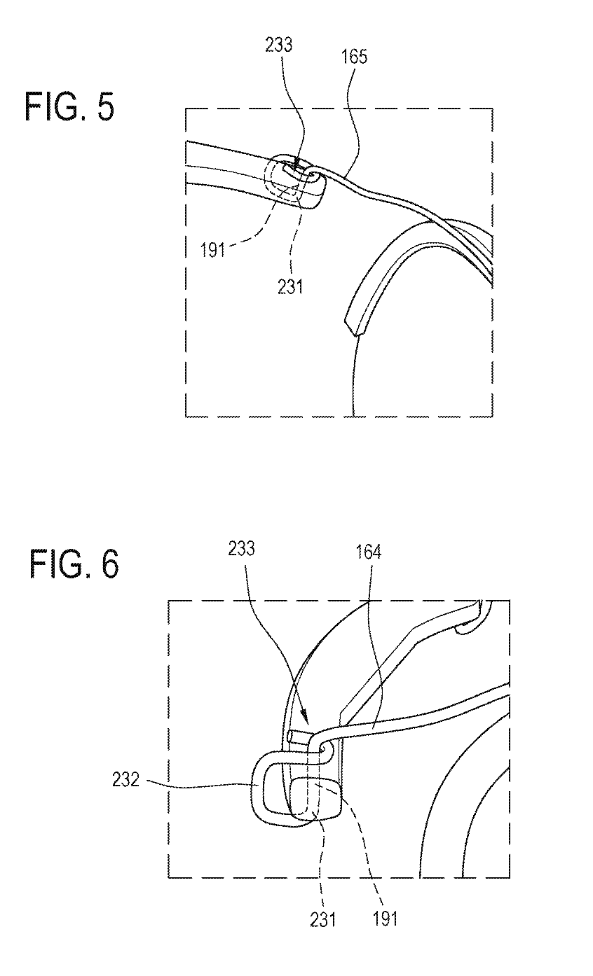

FIGS. 1 to 6 illustrate a first preferred embodiment 10 of eyeglasses comprising lens elements 12, 14, in particular comprising a first and a second lens 121, 141, and means 16 for supporting the lens elements. As illustrated, the lens elements, specifically the corresponding lenses, are adapted to be placed in front of the wearer's eyes.

As may be inferred from the accompanying drawings, the eyeglasses thus have a front part which is adapted to be positioned, in use, on the face, or in front of the face, of the wearer, and which is defined by the lens elements 12, 14 and by the corresponding supporting means 16.

More specifically, the respective lens elements 12, 14 have a front face and a rear face opposite thereto which, in use, is directed towards the wearer's face, as well as a peripheral surface which, in use, defines a top face, an underside face and opposite lateral faces of the lens elements 12, 14 themselves.

More specifically, as may be inferred from the drawings, the lens elements 12, 14 are mounted on the supporting means 16, which keep the lens elements 12 and 14 transversely spaced from each other, in such a way that the respective inner lateral faces of the lens elements 12, 14 are transversely spaced apart.

Advantageously, the supporting means on which the lens elements 12, 14 are mounted comprise metal wire means 16 from which the lens elements 12, 14 are hung.

The eyeglasses thus obtained are light in weight, flexible and, at the same time, very robust.

Advantageously, the lens elements 12, 14 and the supporting means 16 have respective mutual fastening means 13 and 17, respectively.

Advantageously, the mutual fastening means 13 and 17 between the lens elements 12, 14 and the supporting means 16 are provided at mutual point zones, that is, at zones of limited extension of the respective extension of the lens elements 12, 14 and of the supporting means 16.

More specifically, as illustrated, the fastening means 13, 17 are such that the lens elements 12, 14 and/or the supporting means 16 extend laterally, in particular on both sides of the corresponding fastening means 13 and 17.

Advantageously, the lens elements 12, 14 have respective means 13 for fastening them to the supporting means 16 and which are at the top, in particular intermediate, or preferably central, part 129, 149 of the corresponding lens elements 12, 14.

Advantageously, as illustrated, the supporting means 16 have a structure which is preferably symmetrical and which defines transversely opposite first and second bends 161, 162 each adapted to support a respective lens element 12, 14.

Advantageously, the supporting means 16 have respective means 17 for fastening them to the respective lens elements 12, 14 and which are at an intermediate zone of the respective bend 161, 162 for supporting the respective lens elements 12, 14.

Advantageously, as may be inferred from the drawings, the supporting means of the lens elements 12, 14 are in the form of a single element from which the lens elements 12, 14 are preferably hung.

Advantageously, as illustrated, the means, or member, for supporting the lens elements 12, 14 is defined by a metal wire element 16, that is, is in the form of a single metal wire element 16 which supports both the first and second lens elements 12, 14.

More specifically, as may be inferred from the drawings, the means, or member, for supporting the lens elements 12, 14, specifically in the form of a metal wire element 16, extend transversely substantially across the full width of the eyeglasses, that is to say, they define the maximum transverse width of the eyeglasses.

Advantageously, as may be inferred from the drawings, the supporting metal wire element 16 has a curved, undulated shape.

Advantageously, as may be inferred from the drawings, the metal wire element 16 defines the first and second bends 161, 162, at the respective lens elements 12, 14, which are identically shaped and extend on a common connecting bridge portion 163.

Advantageously, as may be inferred from the drawings, the respective bend 161, 162, in particular of the metal wire element 16, has a main portion which is positioned at the top of the respective lens elements 12, 14, in particular at the same height as the top of the respective lens elements 12, 14.

Advantageously, the respective bend 161, 162, in particular of the metal wire element 16, is positioned, or mainly positioned, behind the respective lens elements 12, 14.

Advantageously, the means for fastening the supporting means 16 which are provided on the lens elements 12, 14 comprise respective hole means 13, in particular in the form of corresponding first and second holes 131, 132, defining a respective fastening for the supporting means 16.

Advantageously, the hole means 13, in particular the first and second holes 131, 132 are in the form of through hole means which extend between, and open onto, the front face 12a, 14a and the rear face 12p, 14p of the respective lens elements 12, 14.

Advantageously, the first and second holes 131, 132, defining the fastening hole means 13 provided in the respective lens elements 12, 14 are parallel, or substantially parallel, to each other.

Advantageously, the means 17 for fastening the lens elements 12, 14 which are on the supporting means 16 comprise respective first and second longitudinal portions, in particular pin portions 171, 172 which are inserted into corresponding hole means 17, 17, in particular into the first and second holes 131, 132, which are provided on the respective lens elements 12, 14.

Advantageously, the first and second longitudinal portions, in particular pin portions 171, 172 of the means for fastening to the supporting means 16 are parallel or substantially parallel to each other.

Advantageously, the first and second longitudinal portions 171, 172 for fastening the lens elements 12, 14 which are on the supporting means 16 are connected to each other by a respective transverse portion 173.

Advantageously, the respective transverse connecting portion 173 is positioned in front of the lens elements, that is, in front of the front face 12a, 14a of the lens elements 12, 14, and is preferably slightly spaced therefrom.

More specifically, as illustrated, the respective transverse connecting portion 173 extends horizontally, in use.

More specifically, as illustrated, the transverse portion 173 is connected to the first and second longitudinal portions 171, 172 by corresponding curved connecting portions 1731, 1732.

Advantageously, the first and second longitudinal portions 171, 172 and the corresponding transverse fastening portion 172 are made from metal wire, in particular in the element defining the metal wire supporting means 16.

More specifically, the metal wire supporting portion 16 has a respective diameter, that is to say, it is in the form of a wire with circular cross section.

Advantageously, the respective bend 161, 162, in particular of the metal wire element 16, preferably at a respective intermediate, or central, zone thereof, defines a portion 17 for fastening the respective lens elements 12, 14, which in particular has the general shape of a U and which protrudes longitudinally, in particular, extending forward of the main body of the respective bend and specifically being defined by the first and second longitudinal portions 171, 172 and by the corresponding transverse fastening portion 173.

Advantageously, the lens elements 12, 14 comprise a respective first and second frame piece, or block 120, 140 for mounting a corresponding first and second lens 121, 141, respectively.

More specifically, as illustrated, the first and second frame pieces 120, 140 define a respective groove, not illustrated in detail in the accompanying drawings, for receiving a respective edge, specifically a top edge, of the respective lens 121, 141.

Advantageously, the respective frame piece 120, 140 is positioned mainly at the top 121u, 141u of the respective lens 121, 141, the frame piece 120, 140 being in particular in the form of a respective segment with a generally curved shape and having lateral portions which extend down the side of the lens 121, 141 itself.

Advantageously, in this first preferred embodiment, the metal wire supporting means 16 are connected directly to the frame pieces 120, 140. Advantageously, in this first preferred embodiment, the fastening means 13, that is, the respective fastening holes 131, 132, which are provided on the lens elements, are provided in the respective frame piece 120, 140, in particular at an intermediate zone thereof.

Advantageously, the respective bend 161, 162 of the metal wire element 16 has, on the side opposite to the bridge portion 163, an end portion 164,

165 protruding laterally of the respective lens elements 12, 14 and which, preferably, extends at an angle, in particular slightly at an angle, towards the back, that is, in use, towards the wearer's head.

Advantageously, the end portion 164, 165 protruding laterally of the respective lens elements 12, 14 extends downwardly to a height below that of the part of the respective bend 161, 162 of the metal wire element 16 which is at the respective lens elements 12, 14.

Advantageously, the bridge portion 163 of the metal wire element 16 is curved with convexity which, in use, faces downwardly and extends to a height below that of the part of the respective bend 161, 162 of the metal wire element 16 which is at the respective lens elements 12, 14.

More specifically, as illustrated, the connecting bridge portion 163 between the lens elements 12, 14 extends transversely in the space between the lens elements 12, 14 and is defined by respective metal wire means 16, specifically extending in such a way as to define the fastening bends 161, 162 for the respective lens elements 12, 14.

More specifically, means are provided for engaging and hooking the eyeglasses to the wearer's head, in particular comprising respective sidepiece means, especially a first and a second opposite sidepiece 18, 20 for engaging opposite sides of the wearer's head, preferably the wearer's ears.

More specifically, as illustrated, the respective sidepiece 18, 20 has an elongate block 180, 200 with a generally prismatic, preferably slightly curved shape, from which there extends, in particular extends rearwardly in use, an element 181, 201 for engaging the wearer's ear, and preferably in the form of a respective metal wire element defining means which are looped around the wearer's ear.

Advantageously, the metal wire supporting means 16 define, in particular at the respective lateral end 164, 165, means 22, 24 for the articulated connection of the means 18, 20 for engaging and hooking to the wearer's head.

Advantageously, the means 22, 24 for the articulated connection of the means 18, 20 for engaging and hooking to the wearer's head are in the form of respective hinge portions which comprise at least one pin portion 231 for insertion into a corresponding hole 191, in particular a hole which, in use, is vertical or substantially vertical, of the corresponding sidepiece 18, 20, that is, preferably provided at the end of the corresponding prismatic element 180, 200 of the respective and corresponding sidepiece 18, 20.

Advantageously, the pin portion 231 for insertion into a corresponding hole 191 of the respective and corresponding sidepiece 18, 20 extends downwardly from the end portion 164, 165 of the supporting wire means 16 and/or there extends therefrom a corresponding semi-annular portion 232 which is looped around the end of the sidepiece 18, 20, preferably of the prismatic end element 180, 200 thereof, the semi-annular portion terminating with a hook-shaped retaining portion 233 which is looped around the top end of the pin portion 231.

More specifically, as illustrated, nosepiece means 26, 28 are provided which are rested on the wearer's nose.

More specifically, as illustrated, the nosepiece means 26, 28 comprise pad means 27, preferably made of a soft material, for example an elastomeric material or a silicone material, for resting on the wearer's nose, and corresponding means 261, 281 for supporting these.

Advantageously, the means 261, 281 for supporting the nosepiece pad means 27 have corresponding means 262, 282 for fastening them to the respective lens elements 12, 14.

Advantageously, the lens elements 12, 14 have respective fastening means 29, 29 for the supporting pad means 261, 281.

Advantageously, the fastening means provided on the respective lens elements 12, 14 are in the form of respective hole means, in particular in the form of a first and a second hole 29, 29, preferably parallel, or substantially parallel, to each other.

Advantageously, the hole means 29, 29 in particular the first and second holes, are in the form of through hole means which extend between, and open onto, the front face 12a, 14a and the rear face 12p, 14p of the lens elements 12, 14.

Advantageously, the fastening means, in particular the hole means 29, 29 provided on the lens elements 12, 14, are located on the respective frame piece 120, 140, in particular at the lateral inner part thereof.

Advantageously, the means for supporting the pad means 27 defining the nosepiece are in the form of metal wire means, consisting in particular of a respective single metal wire element 261, 281.

Advantageously, the metal wire means, or element, 261, 281 for supporting the pad means 27 defining the respective nosepiece extend from the respective lens elements 12, 14 towards the central part of the eyeglasses and, in use, preferably downwardly from the respective point where the respective lens elements 12, 14 are fastened.

More specifically, as may be inferred from the drawings, the nosepiece means extend downwardly and inwardly between the first and the second lens element 12, 14.

Advantageously, the metal wire means, or element, 261, 281 for supporting the pad means 27 of the nosepiece have an end portion 262, 282 defining the means for fastening to the respective lens elements 12, 14, in particular having the general shape of a U and preferably defining a first and a second longitudinal pin portion 262p, 282p for insertion into the hole means, specifically into the first and second holes 29, 29 which are provided in the respective lens elements 12, 14. The pin portions 262p, 282p are connected to each other by a corresponding perpendicular connecting portion 263, 283, provided at the face which, in use, is the outer face of the respective lens elements 12, 14.

Advantageously, at the end opposite to the fastening end, the metal wire means, or element, 261, 281 for supporting the pad means 27 of the nosepiece define a groove 264, 284, specifically semi-annular or having the general shape of a C, for fastening the respective pad 27 for resting on the wearer's nose, and in particular having a stem portion 271 for insertion into the receiving groove 264, 284 and especially comprising a wide portion 272 for engaging the wearer's nose at one end of the stem 271 and an enlarged portion 273, provided at the end opposite to the stem 271, for holding the nosepiece within the receiving groove 264, 284.

Advantageously, therefore, the means 16 for supporting the lens elements 12, 14 are in the form of elastically flexible means.

This prevents excessive stress from being transferred to the lens elements and thus enhances the durability of the eyeglasses.

Advantageously, the respective wire means 16, 181, 201, 261, 281 are made of titanium alloy.

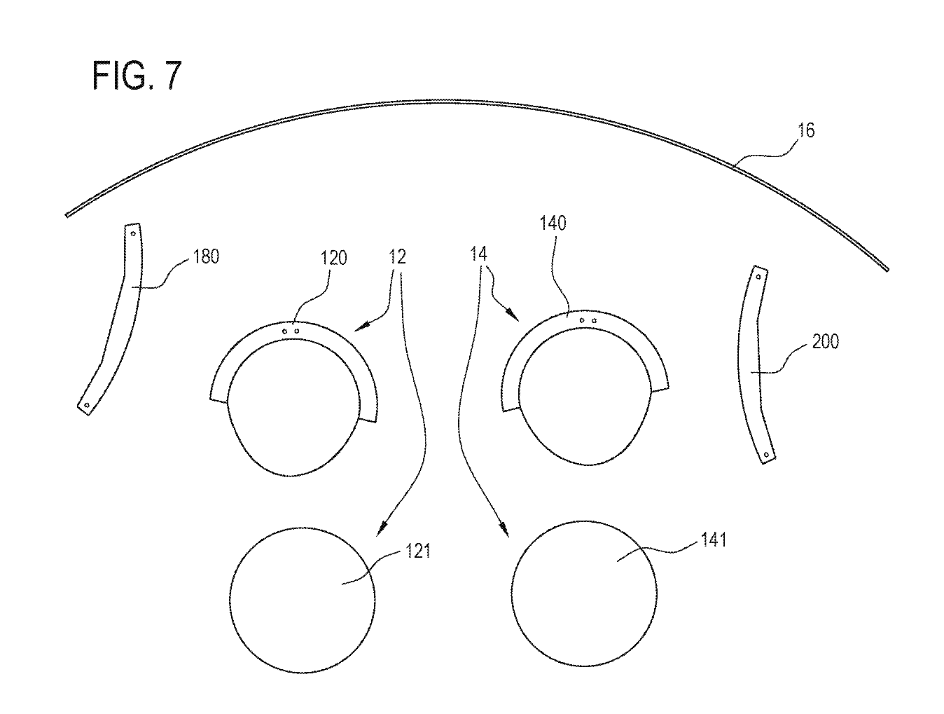

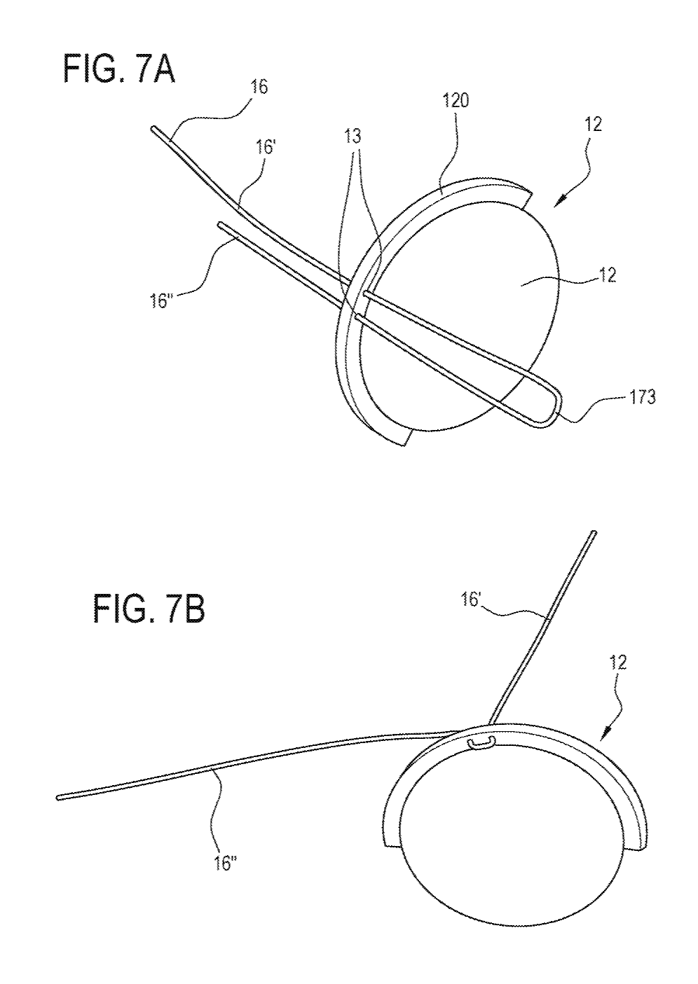

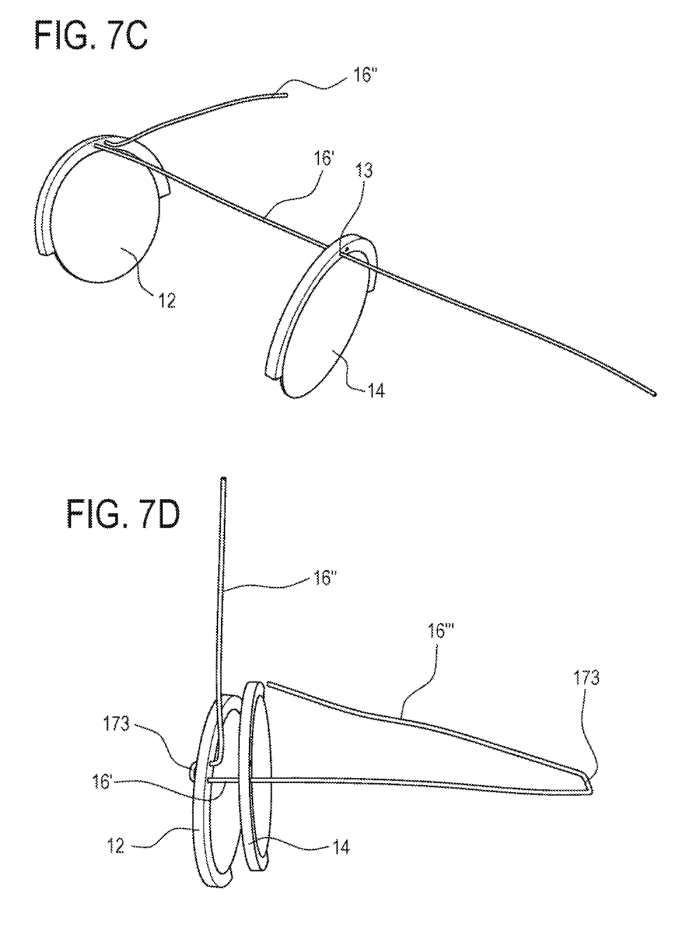

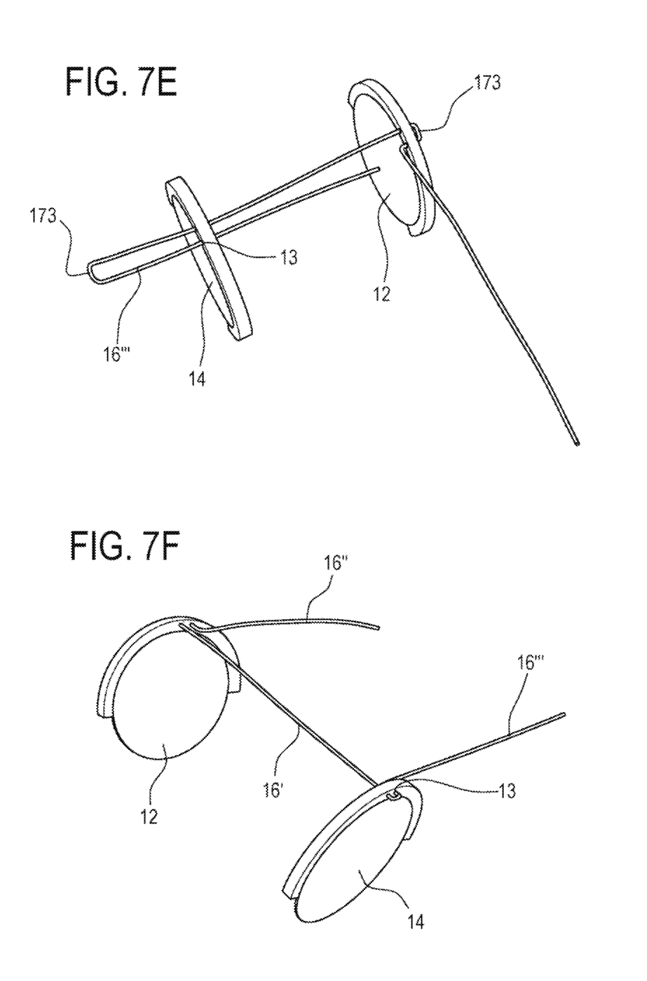

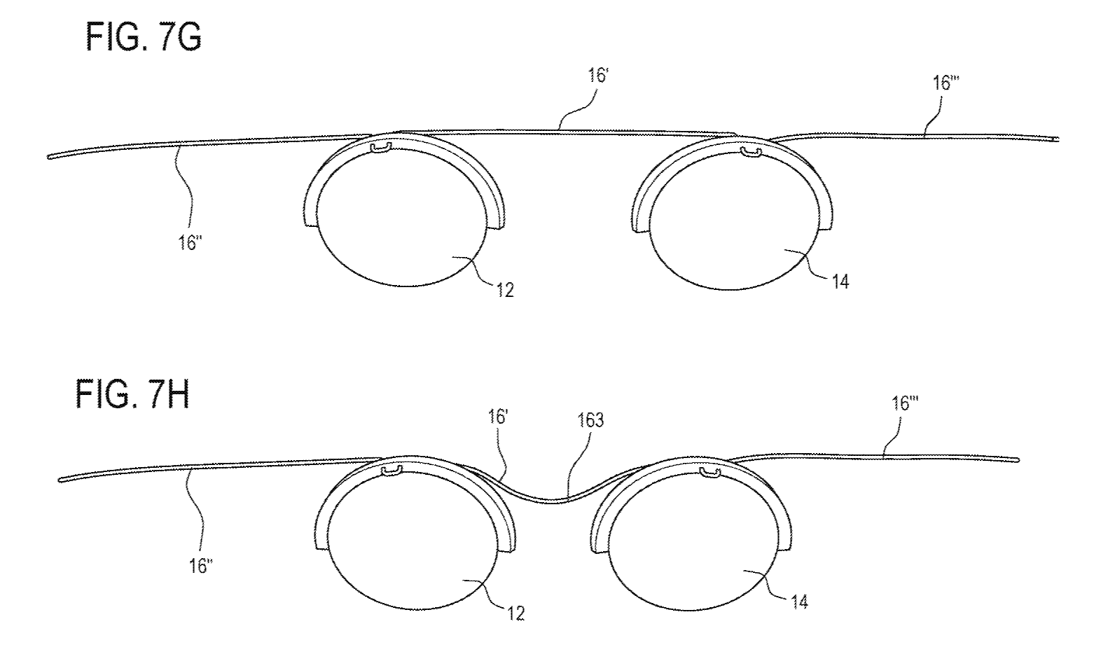

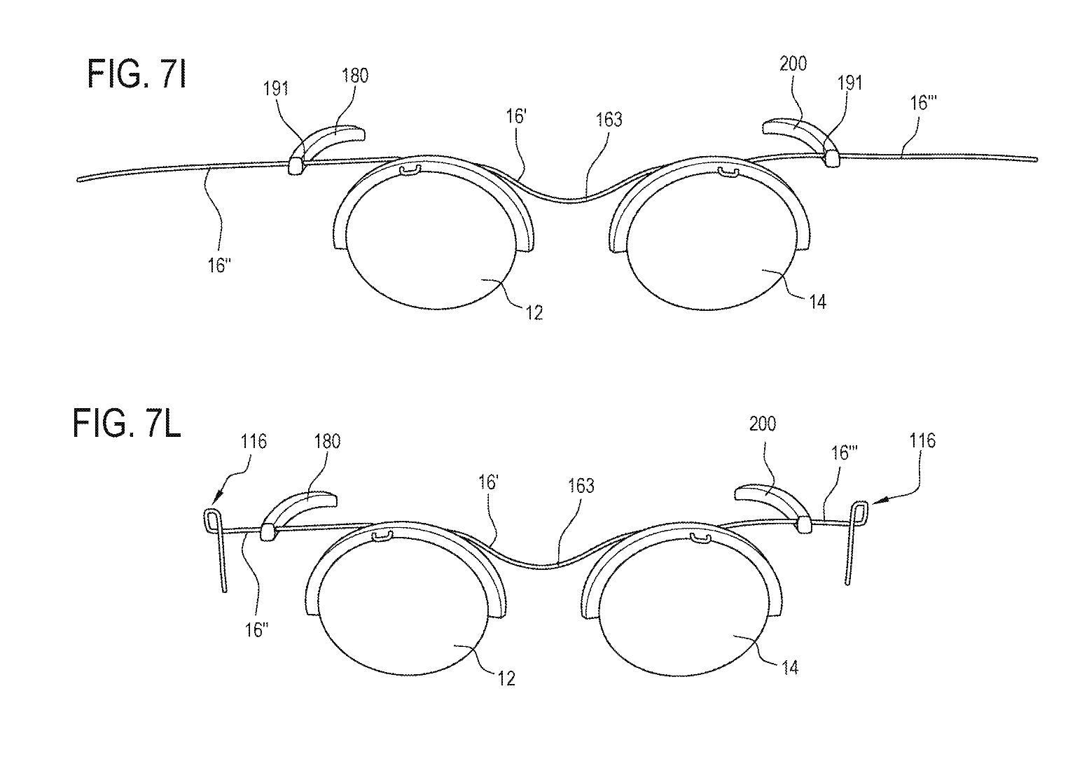

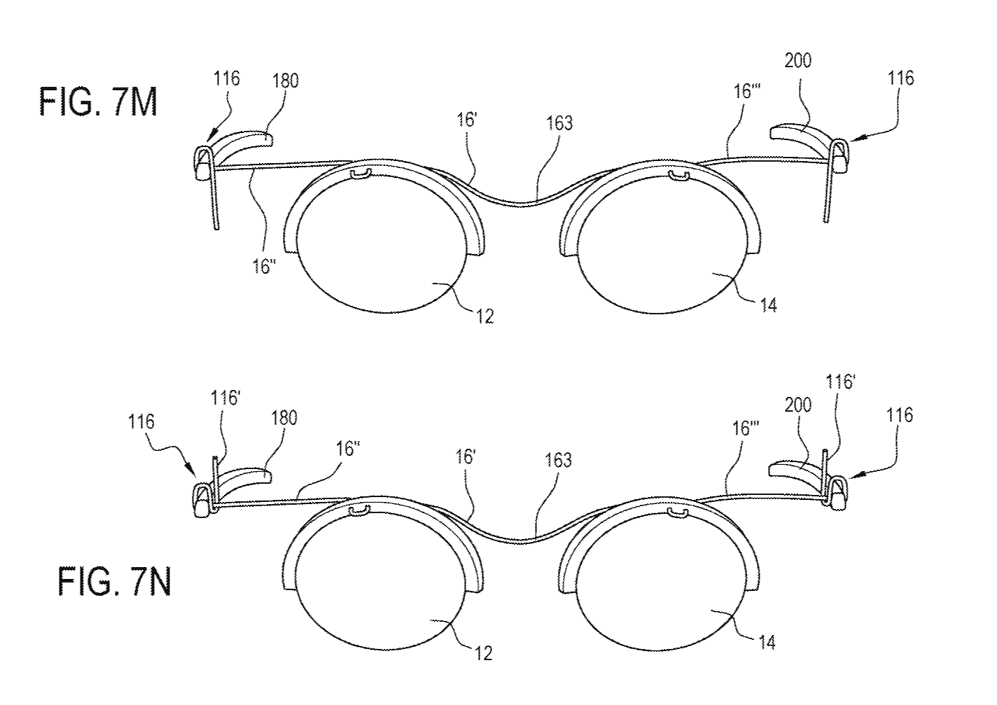

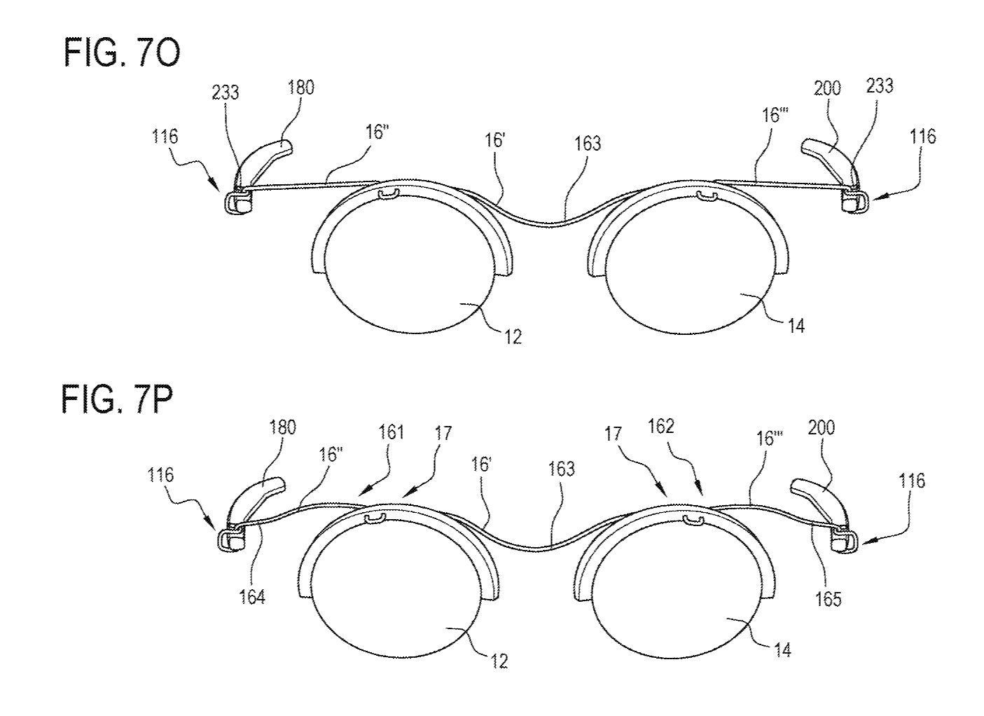

Advantageously, the frame pieces 120, 140, 180, 200 and/or sidepiece elements are made from horn, plastic, metal, wood, ivory or other material. Inferable from FIGS. 7 to 7P is a first preferred embodiment of a method for making or constructing the eyeglasses 10, that is, eyeglasses comprising lens elements 12, 14, in particular comprising a first and a second lens 121, 141 adapted to be placed in front of the wearer's eyes, and means 16 for supporting the lens elements 12, 14.

Advantageously, according to the method, the means for supporting the lens elements 12, 14 are made using metal wire means 16 from which the lens elements 12, 14 are hung.

Advantageously, according to the method, the means for supporting the lens elements 12, 14 are made using elastically flexible means.

Advantageously, according to the method, the means for supporting the lens elements 12, 14 are made using a single metal wire element 16.

More specifically, shown in FIG. 7 are the main components used in the method for making the eyeglasses, that is, the metal wire, preferably of titanium alloy, 16, the lens elements 12 and 14, including the respective lenses 121, 141, the corresponding frame pieces 120, 140, and the prismatic blocks 180, 200 forming part of the eyeglass sidepieces.

As may be inferred from FIG. 7A, in a first step, the metal wire 16, after being suitably bent, is inserted, as illustrated, into the holes 13, 13 made in the lens element 12, in particular in the frame piece 120 thereof.

More specifically, the metal wire 16 has, at this stage, a portion 173 which is adapted to define part of the means 17 for fastening the lens elements 12, there being two legs 16′ and 16″ of the metal wire extending parallel to each other from the portion 173 and adapted to respectively define the bridge element 163, the part of the respective bend 161, adjacent thereto, which supports the same lens element 12 and the entire further bend 162 which supports the other lens element 14, the leg 16″, on the other hand, being in turn adapted to define the remaining, transversely outermost part of the respective bend 161 which supports the lens element 12, including the respective fastening hinge portion 164.

As may be inferred from FIG. 7B, the leg 16″ of the metal wire 16 is then bent by 90° in such a way as to make it parallel to the plane defined by the lens element 12.

At this point, as may be inferred from FIG. 7C, the leg 16′ of the metal wire 16 is inserted into a hole 13 of the other lens element 14.

Next, as may be inferred from FIGS. 7D and 7E, the leg 16′ is in turn bent in such a way as to define a third leg 16′″ which extends from a further portion 173 adapted to define part of the fastening means 17 for the lens element 14, the third leg 16′″ being inserted into the other hole 13 of the other lens element 14.

As may be inferred from FIG. 7F, the third leg 16′″ which is adapted to define the outermost part of the respective bend 162 and the corresponding hinge 165 for articulated fastening of the respective sidepiece is positioned parallel to the respective lens element 14.

As may be inferred from FIG. 7G, the lens elements 12 and 14 are positioned parallel to the intermediate leg 16′. That completes the fastening means 17, 17 made in the metal wire means 16 for the lens elements 12 and 14.

As may be inferred from FIG. 7H, the intermediate leg 16′ is bent in such a way as to define the bridge portion 163 and the inner parts of the respective bends 161, 162 supporting the lens elements 12 and 14.

As may be inferred from FIG. 7I, the blocks 180, 200 which define part of the sidepieces of the eyeglasses are fitted to the outer legs 16″ and 16′″ which are inserted into the holes 191, 191 for the pins 231 of the sidepiece articulation hinges.

At this point, as may be inferred from FIG. 7L, a double 90° bend is made in the portions 16″ and 16′″ which are on the outer side of each sidepiece block 180, 200 to form portions 116, 116 having the general shape of a C with asymmetrical stretches;

At this point, as may be inferred from FIG. 7M, the blocks 180, 200 are brought into abutment against the respective perpendicular leg of the portion 116 which extends directly from the main portion parallel to the respective lens elements 12, 14 of the respective leg 16″, 16′″.

Next, as may be inferred from FIG. 7N, an end portion 116′, 116′ of the portions 116, 116 is bent around the respective leg 16″, 16′″, which is immediately upstream, or on the inside, of the respective sidepiece block 180, 200.

At this point, as may be inferred from FIG. 70, the blocks 180, 200 are rotated by 90° in such a way as to position them below the legs 16″ and 16′″ and thus to define the articulated connection of the respective sidepiece to the supporting metal wire element 16.

After that, as illustrated in FIG. 7P, the portions of the legs 16″ and 16′″ between the respective fastenings 17 for the corresponding lens elements 12, 14 and the sidepiece blocks 180, 200 are bent downwards in such a way as to define the outermost portion of the respective bend 161, 162 for supporting the respective lens elements.

Lastly, all that remains to be done is to associate the metal wire portion 181, 201 of the respective sidepiece with the corresponding block 180, 200.

In practice, the method comprises using or making means or components for the eyeglasses configured as described above for the first preferred embodiment of the eyeglasses.

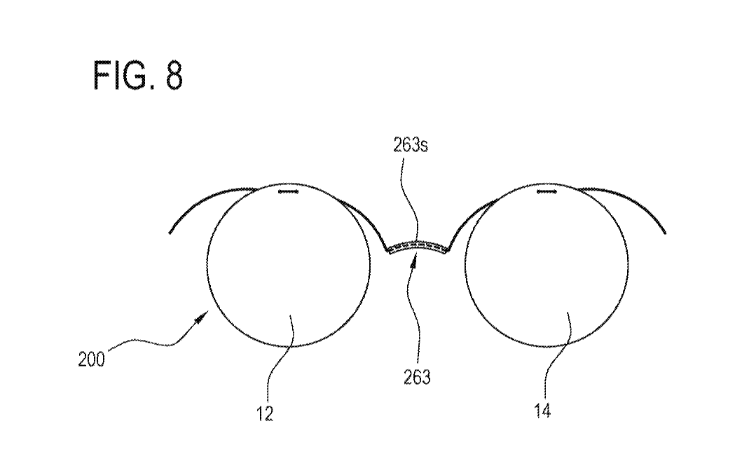

FIG. 8 illustrates a second preferred embodiment 200 of the eyeglasses, comprising components which are similar or equivalent to those of the first embodiment described above; these components are labelled with the same reference numerals and, to avoid an excessively long description, are not described in detail again.

Unlike the first preferred embodiment, the second preferred embodiment 200 of the eyeglasses advantageously comprises nosepiece means for resting on the wearer's nose which are defined by the same bridge portion 263 of the eyeglasses, preferably made from metal wire.

Advantageously, as may be inferred from the drawing, the eyeglass bridge portion 263 has, in use, a downwardly concave shape, that is, concave on the side of the wearer's nose.

Advantageously, as may be inferred from FIG. 8, the nosepiece means 26, 28 for resting on the wearer's nose comprise a covering layer 263s, preferably a piece of silicone tube, for covering the bridge portion 263 of the eyeglasses, this covering layer defining a soft means or layer for resting on the wearer's nose.

Also imaginable, as may be inferred from the second preferred embodiment, is a case where the lens elements 12, 14 consist solely of plain lenses, which are themselves provided with the corresponding hole means, in particular the holes 13, 13 for fastening the supporting wire means 16 and if necessary, in a further embodiment not illustrated, also means 29, 29 for fastening nosepiece means 26, 28 like those of the first preferred embodiment.

In yet another imaginable embodiment not illustrated in the accompanying drawings, the lens elements 12, 14 might have frame pieces for mounting the corresponding lenses and which are shaped in such a way as to extend circumferentially round the entire periphery of the corresponding lens, these frame pieces being provided with the corresponding holes 13, 13 and 29, 29 for fastening the supporting wire means 16 and the nosepiece means 26, 28, respectively.

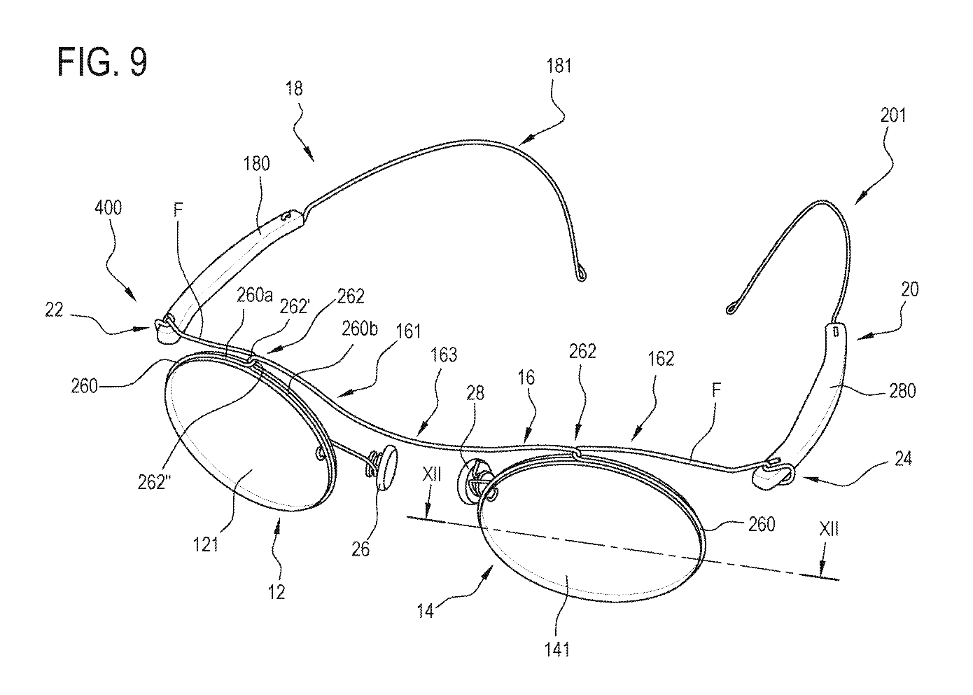

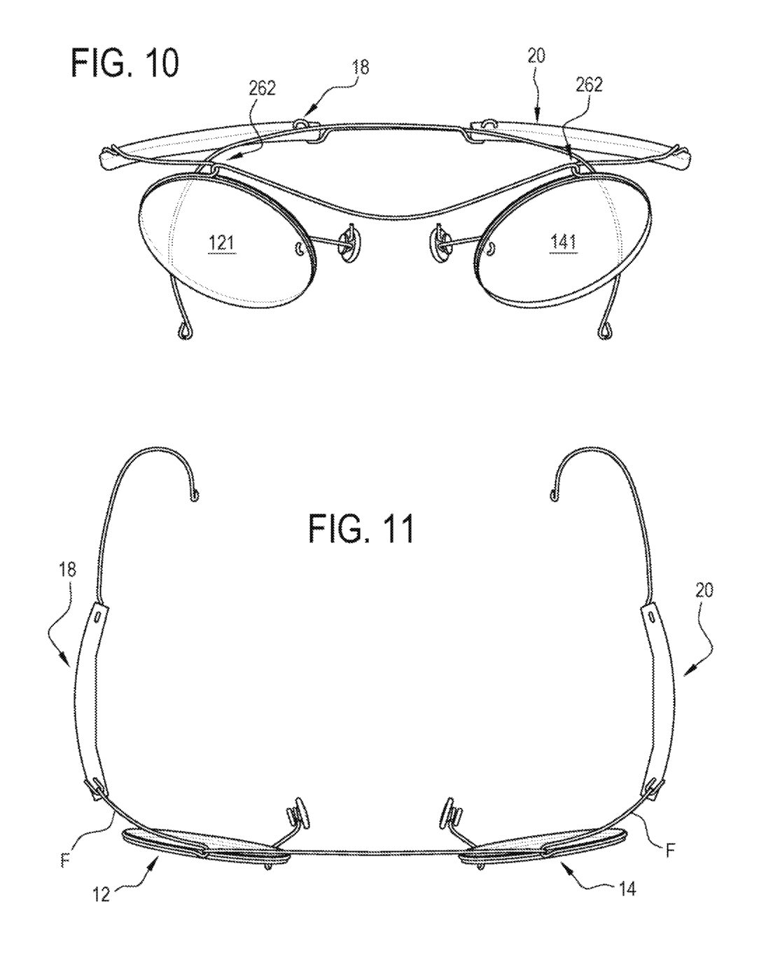

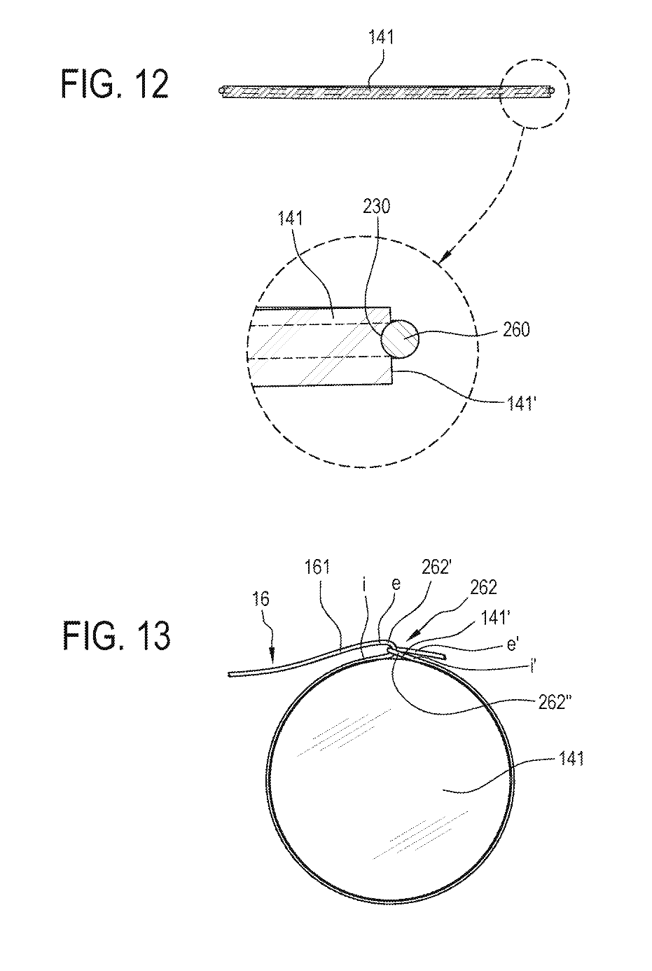

FIGS. 9 to 13 illustrate a third preferred embodiment 400 of the eyeglasses according to this disclosure. The components of the third preferred embodiment which are similar to those of the first preferred embodiment are labelled with the same reference numerals as those used in the description of that embodiment and, to avoid an excessively long description, are not described in detail again.

More specifically, as may be inferred from the drawings, the third preferred embodiment 400 of the eyeglasses also comprises respective supporting means 16 whose structure is preferably symmetrical and which defines transversely opposite first and second bends 161, 162 each adapted to support a respective lens element 12, 14.

More specifically, in the third preferred embodiment 400, too, as in the first preferred embodiment, the respective sidepiece 18, 20 is an elongate block 180, 200 with a generally prismatic shape, preferably slightly curved, from which there extends, in particular extends rearwardly, an element 181, 201 for engaging the wearer's ear, and preferably in the form of a respective metal wire element defining means which are looped around the wearer's ear.

Further, the third preferred embodiment 400 of the eyeglasses also comprises means 22, 24 for the articulated connection of the means, or sidepieces, 18, 20 for engaging and hooking to the wearer's head and which are in the form of respective hinge portions similar in all respects to those of the first preferred embodiment.

Advantageously, as may be inferred from FIGS. 9 to 13, in the third preferred embodiment 400, the supporting metal wire means 16 of the lens elements 12, 14 support and/or surround the lens elements 12, 14, in particular the first and second lens elements 12, 14, that is both the first lens 121 and the second lens separately.

Advantageously, the supporting metal wire means 16 of the lens elements 12, 14 comprise a respective wire portion 260, 260 which is looped round the edge of the self same lens elements 12, 14, in particular of the first or the second lens element 12, 14, preferably of the respective first lens 121, or second lens 141, extending for the entire, or for substantially the entire, perimeter of the self same lens elements 12, 14, in particular of the first or the second lens element 12, 14, preferably of the respective first lens 121, or second lens 141.

Advantageously, as may be inferred from the respective drawings, the wire portion 260, 260 which is looped round the edge of the self same lens elements 12, 14, in particular of the first and the second lens element 12, 14, preferably of the respective first lens 121, or second lens 141, extends under the respective lateral bend 161, 162 which supports the respective lens element 12, 14.

Advantageously, as may be inferred from FIGS. 9 to 13, the supporting metal wire means 16, that is, the respective wire portion 260, 260 which is looped round the edge of the lens elements 12, 14, in particular of the first or the second lens element 12, 14, preferably of the respective first lens 121, or second lens 141, are inserted into a corresponding groove 230 which is formed in the outer peripheral edge of the lens elements 12, 14, in particular in the first or the second lens element 12, 14, preferably in the respective first lens 121, or second lens 141.

Advantageously, as may be inferred from FIGS. 9 to 13, the supporting metal wire means 16 of the lens elements 12, 14 comprise a metal wire element 16, that is, they are defined by a single metal wire element 16, which supports and surrounds the lens elements 12, 14, in particular the first and second lens elements 12, 14, preferably both the first lens 121 and the second lens 141, in particular also defining the bridge or bridge portion 163 of the eyeglasses which extends between the first and the second lens 121, 141.

Advantageously, as may be inferred from FIGS. 9 to 13, means 262 are provided for mutually fastening, in particular hooking, to opposite legs 260a, 260b, that is, to the two legs which extend in opposite directions, of the metal wire portion 260 which supports and surrounds the lens elements 12, 14, in particular the first and second lens elements 12, 14, preferably both the first lens 121 and the second lens 141.

Advantageously, as may be inferred from FIGS. 9 to 13, the means 262 for mutually fastening, in particular hooking, to opposite legs 260a, 260b of the metal wire portion 260 which supports and surrounds the lens elements 12, 14 are in the form of corresponding hook means, in particular in the form of a respective hook, and preferably in the form of first and second hook elements 262, 262, each provided at the respective first and second lens elements 12, 14, preferably at the respective first lens 121 and second lens 141.

Advantageously, as may be inferred from FIGS. 9 to 13, the respective hook element 262 is provided at the top of the respective first and second lens elements 12, 14, preferably at the first lens 121 and second lens 141, or at the centre line of the self same first and second lens elements 12, 14, that is, of the first lens 121 and second lens 141.

Advantageously, as may be inferred from FIGS. 9 to 13, the respective hook element comprises a first and a second leg of the wire which are looped round each other in at least one coil 262′, 262″ and which extend towards laterally opposite directions of the eyeglasses or of the respective lens.

Advantageously, as may be inferred from FIGS. 9 to 13, the respective hook element 262 comprises a respective coil, preferably a first and a second coil 262′, 262″ of the metal wire portion 260 which supports and surrounds the lens elements 12, 14, the coils 262′, 262″ being looped round each other and, once looped, extending towards laterally opposite directions of the eyeglasses or of the respective lens.

Advantageously, as may be inferred in particular from FIG. 13, the respective coil has an angular extension of 180°, or substantially 180°, that is, it defines legs (e), (e′) leading out of the hook 262 and extending towards, or in the same direction as, the corresponding leg (i), (i′) leading into the self same hook 262.

Advantageously, as may be inferred from FIGS. 9 to 13, the respective hook element 262 is detached, in particular at the top, from the respective edge 141′, in particular top edge, of the lens elements 12, 14, in particular of the first or second lens elements 12, 14, that is, of the respective first lens 121 or second lens 141.

Advantageously, as may be inferred in particular from FIG. 13, the first and second coils 262′, 262″ of the metal wire portion 260 engage each other at a point which is detached, in particular detached at the top, from the respective edge 141′, in particular from the top thereof, of the lens elements 12, 14, that is, of the first or second lens element 12, 14, that is, of the respective first lens 121 or second lens.

Advantageously, as may be inferred from FIGS. 9 to 13, the leg (e) of the eyeglasses which leads out of the hook element 262 and extends towards the central part of the eyeglasses defines the bridge, or bridge portion, 163 of the self same eyeglasses.

Advantageously, as may be inferred from FIGS. 9 to 13, the leg (e′) of the metal wire portion 260 which leads out of the hook element 262 and extends towards the lateral part of the eyeglasses goes to make up a lateral front portion F of the frame or, as will become clearer as this description continues, the respective sidepiece 18, 20 of the eyeglasses. In practice, the element, or single metal wire element 16, defines the mutual fastening means, or the respective hook element 262, 262, that is, the respective coils 262′, 262″ of the hook.

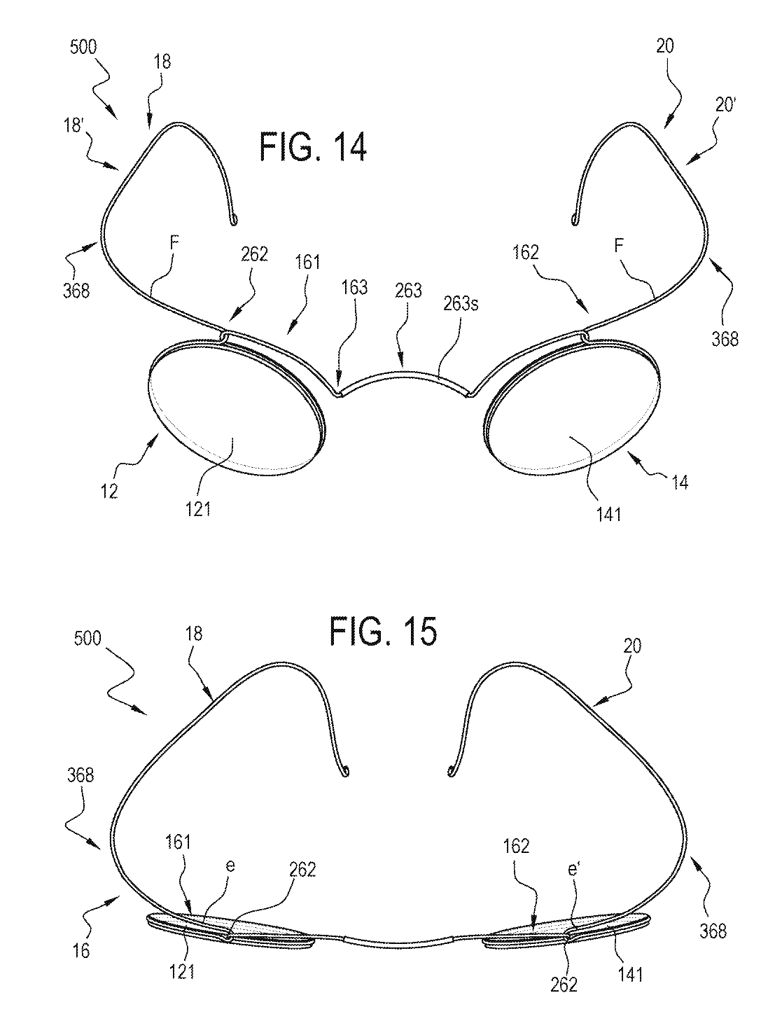

A fourth embodiment 500 is illustrated in FIGS. 14 and 15. The components of the fourth preferred embodiment which are similar to those of the preferred embodiments described above are labelled with the same reference numerals as those used in the description of those embodiments and, to avoid an excessively long description, are not described in detail again.

Advantageously, as may be inferred from FIGS. 14 and 15, the supporting metal wire means 16 of the lens elements 12, 14 in the fourth preferred embodiment 500 are defined by a single metal wire element 16 which extends to define the sidepiece or sidepieces 18, 20, in particular the entire sidepiece or sidepieces of the eyeglasses, and especially the front part 161, 162, 163 of the self same supporting metal wire means 16. Advantageously, as may be inferred from FIGS. 14 and 15, the supporting metal wire means 16 of the lens elements 12, 14 defined by a single metal wire element 16, which extends to define the sidepiece or sidepieces of the eyeglasses, support and surround the lens elements 12, 14, in particular the first and second lens elements 12, 14, preferably the first lens 121 and the second lens 141.

Advantageously, as may be inferred from FIGS. 14 and 15, the supporting metal wire means 16 of the lens elements 12, 14, in particular defined by a single metal wire element 16, extend to define a wide, curved portion 368, 368 defining flexible articulations which extend into the respective main sidepiece portions, in particular with a linear or substantially linear shape, 18′, 20′ and which, at rest, preferably converge on each other.

Advantageously, as may be inferred from FIGS. 14 and 15, in the fourth preferred embodiment 500, too, the supporting metal wire means 16 of the lens elements 12, 14, that is, the single metal wire element 16, define the front part 161, 162, 163 of the self same supporting metal wire means 16 from a respective lateral end of which there extends the wide, curved portion 368, 368 defining a flexible articulation which extends into the respective main sidepiece portion.

Advantageously, as may be inferred from FIGS. 14 and 15, the wide, curved sidepiece portion 368, 368 defining a flexible articulation which extends into the respective main sidepiece portion is convex laterally of the eyeglasses.

Advantageously, as may be inferred from FIGS. 14 and 15, the wide, curved flexible articulation portion 368, 368 connects the respective main sidepiece portion 18′, 20′ and the corresponding lateral portions F, F of the front part 161, 162, 163 of the self same supporting metal wire means 16 make an angle of less than 90° with each other.

Advantageously, as may be inferred from FIGS. 14 and 15, the sidepiece portion 18′, 20′, also in the fourth preferred embodiment 500, extends to define the element 18″, 20″ for engaging the wearer's ear and is preferably in the form of means which, in use, are looped round the wearer's ear. In practice, advantageously, as may be inferred from FIGS. 14 and 15, the entire frame 16 supporting the lens elements 12, 14 is defined by a single metal wire element 16.

As in the second preferred embodiment of the eyeglasses, the fourth preferred embodiment also has means for resting on the wearer's nose and which comprise an arcuate portion 263 which, in use is downwardly concave, and which has on it a covering layer 263s, preferably in the form of a silicone tube, for covering the arcuate rest portion 263 of the eyeglasses, this covering layer defining a soft means or layer for resting on the wearer's nose.

It is understood that, the metal wire means, that is, the respective metal wire element 16 of all the embodiments described above are made preferably of titanium alloy and/or have a circular transverse cross section, making the eyeglasses particularly flexible and light on the user and thus comfortable and pleasant to wear. It is also understood that the lens frame 12a, 14a of the first preferred embodiment might also be shaped in such a way as to completely surround the respective lens, that is to say, that the frame 12a, 14a might be omitted, in which case only the lenses 12, 14 hooked to the fastening means 17 would remain.

Furthermore, the fastening means 17 preferably have a widthways extension, or distance between the pin portions 171, 173, which is preferably less than half the width of the corresponding lens element, or lens, more preferably, less than a quarter of the width of the corresponding lens element, or lens, and still more preferably less than a fifth of the width of the corresponding lens element, or lens, and specifically, a widthways extension, or distance between the pin portions 171, 173 of the fastening means 17, which is between 2 mm and 12 mm, preferably between 3 mm and 6 mm and optimally around 4 mm.

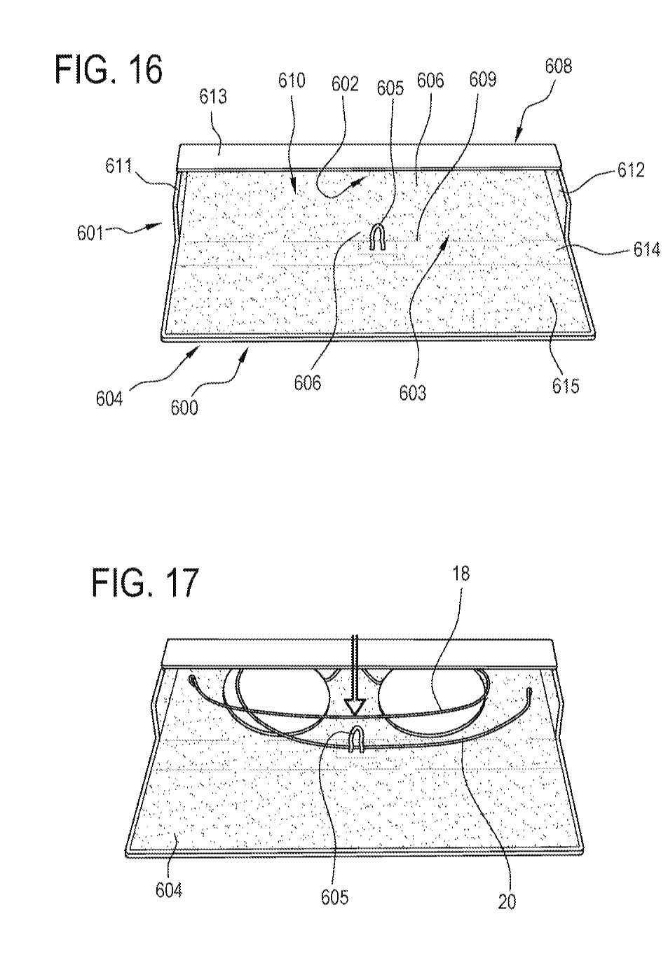

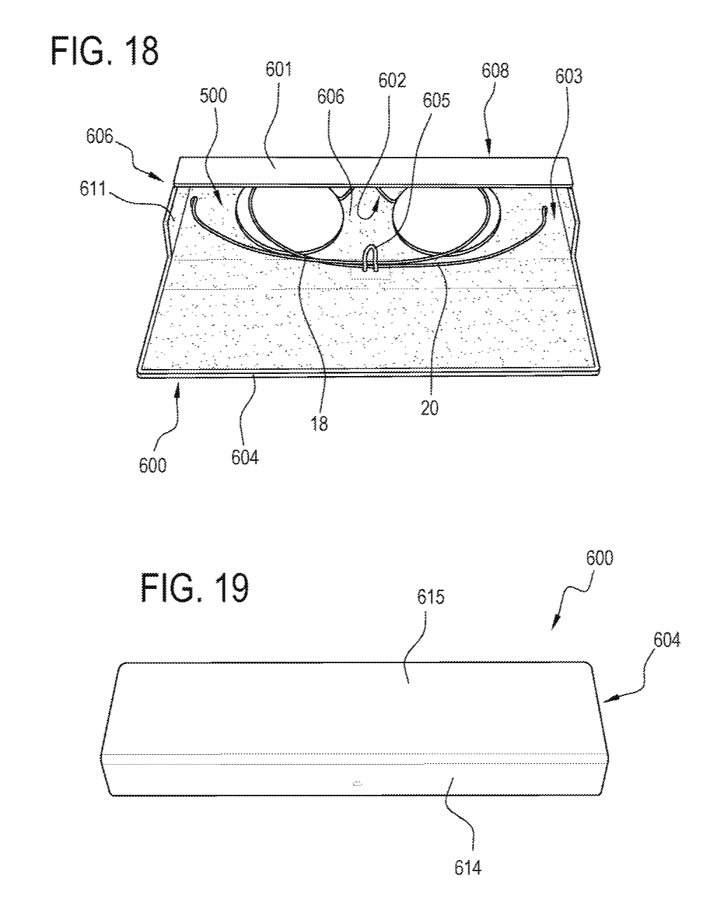

FIGS. 16 to 19 illustrate a preferred embodiment of a case 600 for holding the eyeglasses 500, in particular in the form of eyeglasses according to the above described fourth preferred embodiment 500, the case comprising a containing body 601 defining a chamber 602 for receiving the eyeglasses and having an opening 603 for putting the eyeglasses into, and taking them out of, the receiving chamber, the case further comprising a lid 604 which is connected in articulated fashion to the containing body 601 and which is movable between an open position for taking the eyeglasses out of, and/or putting them into, the case and a position where the receiving chamber is closed.

Advantageously, the containing body 601 is provided with means 605 for engaging and retaining a corresponding part of the eyeglasses, in particular for a respective sidepiece of the eyeglasses, preferably for both of the sidepieces 18, 20 of the eyeglasses.

That way, it is possible to conveniently hold the eyeglasses, in particular eyeglasses having inherent elastic properties, inside the case and it is particularly quick and easy for the user to put them in and take them out. Advantageously, as may be inferred from FIGS. 16 to 19, when the eyeglasses are at rest inside the receiving chamber of the case, the corresponding part of the eyeglasses, in particular the respective sidepiece, preferably each of the sidepieces 18, 20 are elastically pressed against the engagement and retaining means 605.

Advantageously, as may be inferred from FIGS. 16 to 19, the body 601 of the case has a respective surface 606 on which the eyeglasses 500 are rested.

Advantageously, as may be inferred from FIGS. 16 to 19, the engagement and retaining means are in the form of means 605 which protrude from a corresponding surface 606, preferably inside the body 601 of the case, the surface 606 preferably being the surface which supports the eyeglasses when they are at rest.

Advantageously, as may be inferred from FIGS. 16 to 19, the engagement and retaining means 605 are in the form of means which are open on one side to insertably receive the corresponding part of the eyeglasses, in particular a respective sidepiece, preferably both of the sidepieces 18, 20 of the eyeglasses.

Advantageously, as may be inferred from FIGS. 16 to 19, the engagement and retaining means 605 are open towards a corresponding wall, in particular a rear wall, 608 of the containing body 601 against which the eyeglasses 500 are rested.

Advantageously, as may be inferred from FIGS. 16 to 19, the engagement and retaining means 605 are located half way along the containing body 601, that is, as illustrated, at the lid 604, and in particular, at the front wall 614 of the self same lid, and preferably, as illustrated, in proximity to the edge 609 by which lid 604 is articulated to the containing body 601. Preferably, as may be inferred from the drawings, the engagement and retaining means 605 rotate with the respective wall 614 of the lid 604 in such a way as to hold the corresponding part of the eyeglasses against the supporting surface 606 thereof.

Advantageously, as may be inferred from FIGS. 16 to 19, the engagement and retaining means 605 are in the form of an elongate element, in particular bent into a semi-annular shape, which is preferably inclined at an angle to the supporting surface 606 for resting the eyeglasses and which is preferably flexible.

Advantageously, as may be inferred from FIGS. 16 to 19, the part of the case defining the housing for the eyeglasses, or containing body 601, comprises, in a condition for use, a bottom wall 610, in particular defining the eyeglass supporting surface 606, and/or opposite lateral walls 611, 612 which extend, preferably perpendicularly, from the lateral edges of the bottom wall 610 and/or a rear wall 608 for engaging the eyeglasses when they are held inside the case, the rear wall 608 extending, preferably perpendicularly, from the end side, in particular the long end side, of the bottom wall 610 and/or, as illustrated, possibly a top wall 613, preferably shorter than the lateral walls 611, 612 and/or the bottom wall 610, the top wall 613, if present, extending from the rear wall 608, in particular lying parallel or substantially parallel to the bottom wall 610.

Advantageously, as may be inferred from FIGS. 16 to 19, the part of the case defining the lid 604 which closes the housing comprises an end wall 614 which is articulated, in particular along the long side, to the bottom wall 610 of the containing body 601 with which it is aligned and coplanar when in the open condition and which, when in the closed condition extends upwards parallel or substantially parallel to the opposite rear wall 608 of the containing body 601 for engaging the eyeglasses, there being, as illustrated, extending in articulated fashion from the end wall 614, in particular along the long side thereof, opposite to that by which the bottom wall 610 of the containing body 601 is articulated, a second wall 615 for closing the housing which, in use, in the closed condition, defines at least part of the top or front wall of the case and, in the open condition, is preferably coplanar with the end wall 614 of the lid and/or with the bottom wall 610 of the containing body 601.

Advantageously, as may be inferred from FIGS. 16 to 19, the end wall 614 of the case, which defines the lid 604 for closing the housing, is articulated to the bottom wall 610 of the containing body 601 in such a way as to able to adopt a position such as to make a corresponding obtuse angle with the bottom wall 610 of the containing body 601, in particular so as to allow quickly and automatically releasing the respective part, preferably the sidepiece, or the first and second sidepieces of the eyeglasses, elastically from the corresponding engagement and retaining means 605.

In practice, as is evident, the technical features described above, individually or in combination, allow this invention to achieve one or more of the following advantageous results:

providing eyeglasses with a low risk of breakage;

providing eyeglasses with high durability;

providing high-strength eyeglasses;

providing eyeglasses whose structure is such as to be able to prevent stress and strain from reaching excessively high levels;

providing eyeglasses whose structure is such as to be able to prevent excessively high stress peaks;

providing eyeglasses which allow saving on the number of components used to make them;

providing eyeglasses which allow dispensing with the use of unwanted components;

providing eyeglasses which are particularly light in weight;

providing eyeglasses which are particularly comfortable and easy to wear;

providing eyeglasses whose structure is particularly flexible or compliant;—providing eyeglasses which are easy to adapt to the physical or morphological features of the wearer's face and/or head;

providing eyeglasses whose cost of production is relatively limited.

In particular, with these eyeglasses, the stress applied when the sidepieces are spread apart to put them on or take them off the wearer's face, or for other accidental reasons, does not practically apply any strain on the lens elements and, in particular, on the actual lenses of the eyeglasses.

The invention described above is susceptible of industrial application. It would be obvious to one skilled in the art that several changes and modifications can be made to the invention without departing from the spirit and scope of the invention, described in depth above. Also, further preferred embodiments of the invention comprising one or more of the features described herein can easily be imagined. It will also be understood that all the details of the invention may be replaced by technically equivalent elements.

1. Eyeglasses (10) comprising lens elements (12, 14), in particular comprising a first and a second lens (121, 141), adapted to be placed in front of the wearer's eyes, and means (16) for supporting the lens elements (12, 14), characterized in that the means for supporting the lens elements (12, 14) comprise metal wire means (16) from which the lens elements (12, 14) are hung.

2. The eyeglasses according to claim 1 or according to the preamble to claim 1, characterized in that the lens elements (12, 14) and the supporting means (16) have respective mutual fastening means (13 and 17).

3. The eyeglasses according to claim 2, characterized in that the lens elements (12, 14) and the supporting means (16) have respective mutual fastening means (13 and 17) which are provided at mutual point zones, that is, at zones of limited extension of the respective extension of the lens elements (12, 14) and of the supporting means (16) and which, in particular, are such that the lens elements (12, 14) and/or the supporting means (16) extend laterally, in particular on both sides of the corresponding fastening means (13 and 17).

4. The eyeglasses according to claim 2 or 3, characterized in that the lens elements (12, 14) have respective means (13) for fastening them to the supporting means (16) and which are at the top, in particular intermediate, or preferably central, part (129, 149) of the corresponding lens elements (12, 14).

5. The eyeglasses according to any one of the preceding claims or according to the preamble to claim 1, characterized in that the supporting means (16) have a structure which is preferably symmetrical and which defines transversely opposite first and second bends (161, 162) adapted to support the lens elements (12, 14), respectively, and in that the supporting means (16) have respective means (17) for fastening them to the lens elements (12, 14) and which are at an intermediate zone of the respective bend (161, 162) for supporting the respective lens elements (12, 14).

6. The eyeglasses according to any one of the preceding claims or according to the preamble to claim 1, characterized in that the means for supporting the lens elements (12, 14) are in the form of a single member which the lens elements (12, 14) are preferably hung from, and in that the means, or member, for supporting the lens elements (12, 14) are defined by a metal wire element (16), that is, is in the form of a single metal wire element (16) which supports both the first and second lens elements (12, 14).

7. The eyeglasses according to any one of the preceding claims or according to the preamble to claim 1, characterized in that the means, or member, for supporting the lens elements (12, 14) are in the form of a metal wire element (16) and extend transversely substantially across the full width of the eyeglasses, that is to say, they define the maximum transverse width of the eyeglasses.

8. The eyeglasses according to claim 6 or 7, characterized in that the metal wire element (16) defines the first and second bends (161, 162), at the respective lens elements (12, 14), which are identically shaped and extend on a common connecting bridge portion (163).

9. The eyeglasses according to any one of claims 5 to 8, characterized in that the respective bend (161, 162), in particular of the metal wire element (16), has a main portion which is positioned at the top of the respective lens elements (12, 14), in particular at the same height as the top of the respective lens elements; and/or in that the respective bend (161, 162), in particular of the metal wire element (16), is positioned, or mainly positioned, behind the respective lens elements (12, 14).

10. The eyeglasses according to any one of the preceding claims or according to the preamble to claim 1, characterized in that the means for fastening the supporting means (16) which are provided on the lens elements (12, 14) comprise respective hole means (13), in particular in the form of corresponding first and second holes (131, 132), defining a respective fastening for the supporting means; and in particular in that the hole means (13), in particular the first and second holes (131, 132) are in the form of through hole means which extend between, and open onto, the front face (12a, 14a) and the rear face (12p, 14p) of the lens elements (12, 14).

11. The eyeglasses according to any one of the preceding claims or according to the preamble to claim 1, characterized in that the means (17) for fastening the lens elements (12, 14) which are on the supporting means (16) comprise respective first and second longitudinal portions, in particular pin portions (171, 172) which are inserted into corresponding hole means (17, 17), in particular into the first and second holes (131, 132), which are provided on the respective lens elements; and in that the first and second longitudinal portions (171, 172) for fastening the lens elements (12, 14) which are on the supporting means (16) are connected to each other by a respective transverse portion (173).

12. The eyeglasses according to claim 11, characterized in that the respective transverse connecting portion (173) is positioned in front of the lens elements, that is, in front of the front face (12a, 14a) of the lens elements (12, 14), and preferably slightly spaced therefrom.

13. The eyeglasses according to any one of claims 5 to 12, characterized in that the respective bend (161, 162), in particular of the metal wire element (16), preferably at a respective intermediate, or central, zone thereof, defines a portion (17) for fastening the respective lens elements (12, 14) and which, in particular, has the general shape of a U protruding longitudinally, in particular, extending forward of the main body of the respective bend and especially being defined by the first and second longitudinal portions (171, 172) and by the corresponding transverse fastening portion (173).

14. The eyeglasses according to any one of the preceding claims, characterized in that the lens elements (12, 14) comprise a respective first and second frame piece, or block (120, 140), mounting a corresponding first and second lens, respectively; and in particular in that the supporting metal wire means (16) are connected directly to the frame pieces (120, 140).

15. The eyeglasses according to any one of claims 5 to 14, characterized in that the respective bend (161, 162) of the metal wire element (16) has, on the side opposite to the bridge portion (163), an end portion (164, 165) protruding laterally of the respective lens elements (12, 14) and which, preferably, extends at an angle, in particular slightly at an angle, towards the back, that is, in use, towards the wearer's head.

16. The eyeglasses according to any one of the preceding claims, characterized in that it comprises means for engaging and hooking the eyeglasses to the wearer's head, in particular comprising respective sidepiece means, especially a first and a second opposite sidepiece (18, 20) for engaging opposite sides of the wearer's head, preferably the wearer's ears; and in particular in that the respective sidepiece (18, 20) has an elongate block (180, 200) with a generally prismatic, preferably slightly curved shape, from which there extends, in particular extends rearwardly in use, an element (181, 201) for engaging the wearer's ear, and preferably in the form of a respective metal wire element defining means which are looped around the wearer's ear.

17. The eyeglasses according to any one of the preceding claims, characterized in that the supporting metal wire means (16) define, in particular at the respective lateral end (164, 165), means (22, 24) for the articulated connection of the means (18, 20) for engaging and hooking to the wearer's head.

18. The eyeglasses according to claim 17, characterized in that the means (22, 24) for the articulated connection of the means (18, 20) for engaging and hooking to the wearer's head are in the form of respective hinge portions which comprise at least one pin portion (231) for insertion into a corresponding hole (191), in particular a hole which, in use, is vertical or substantially vertical, of the corresponding sidepiece (18, 20), that is, preferably provided at the end of the corresponding prismatic element (180, 200) of the respective and corresponding sidepiece (18, 20).

19. The eyeglasses according to claim 18, characterized in that the pin portion (231) for insertion into a corresponding hole (191) of the respective and corresponding sidepiece (18, 20) extends downwardly from the end portion (164, 165) of the supporting wire means (16) and/or there extends therefrom a corresponding semi-annular portion (232) which is looped around the end of the sidepiece (18, 20), preferably of the prismatic end element (180, 200) thereof, the semi-annular portion terminating with a hook-shaped retaining portion (233) which is looped around the top end of the pin portion (231).

20. The eyeglasses according to any one of the preceding claims, characterized in that it comprises nosepiece means (26, 28) to be rested on the wearer's nose.

21. The eyeglasses according to claim 20, characterized in that the nosepiece means (26, 28) comprise pad means (27), preferably made of a soft material, for example an elastomeric material, for resting on the wearer's nose, and corresponding means (261, 281) for supporting these.

22. The eyeglasses according to claim 20 or 21, characterized in that the lens elements (12, 14) have respective means (29, 29) for fastening the pad supporting means; in particular in that the fastening means provided on the lens elements (12, 14) are in the form of respective hole means, in particular in the form of a first and a second hole (29, 29), preferably parallel, or substantially parallel, to each other; especially in that the fastening means, in particular the hole means (29, 29), provided on the lens elements (12, 14) are at the respective frame piece (120, 140), in particular at the side thereof;
and preferably in that the means for supporting the pad means (27) defining the respective nosepiece are in the form of metal wire means, consisting in particular of a respective single metal wire element (261, 281).

23. The eyeglasses according to claim 20, characterized in that the nosepiece means for resting on the wearer's nose are defined by the same bridge portion (263) of the eyeglasses, preferably made from metal wire.

24. The eyeglasses according to claim 23, characterized in that the bridge portion (263) of the eyeglasses has, in use, a downwardly concave shape, that is, concave on the side of the wearer's nose; and/or in that the nosepiece means (26, 28) for resting on the wearer's nose comprise a covering layer (263s), preferably a piece of silicone tube, for covering the bridge portion (263) of the eyeglasses, this covering layer defining soft means for resting on the wearer's nose.

25. The eyeglasses according to any one of the preceding claims, characterized in that the respective wire means (16, 181, 201, 261, 281) are made of titanium alloy; and/or in that the frame pieces and/or sidepiece elements (120, 140, 180, 200) are made from horn, plastic, metal, wood, ivory or other material.

26. The eyeglasses according to any one of the preceding claims or according to the preamble to claim 1, characterized in that the supporting metal wire means (16) of the lens elements (12, 14) support and/or surround the lens elements (12, 14), in particular the first and second lens elements (12, 14), preferably both the first lens (121) and the second lens (141) separately.

27. The eyeglasses according to claim 26, characterized in that the supporting metal wire means (16) of the lens elements (12, 14) comprise a respective wire portion (260, 260) which is looped round the edge of the self same lens elements (12, 14), in particular of the first and the second lens element (12, 14), preferably of the respective first lens (121), or second lens (141), extending for the entire, or for substantially the entire, perimeter of the self same lens elements (12, 14), in particular of the first and the second lens element (12, 14), preferably of the respective first lens (121), or second lens (141).

28. The eyeglasses according to claim 27, characterized in that the wire portion (260, 260) which is looped round the edge of the self same lens elements (12, 14), in particular of the first and the second lens element (12, 14), preferably of the respective first lens (121), or second lens (141), extends under the respective lateral bend (161, 162) which supports the respective lens element (12, 14).

29. The eyeglasses according to any one of claims 26 to 28, characterized in that the supporting metal wire means (16), that is, the respective wire portion (260, 260) which is looped round the edge of the lens elements (12, 14), in particular of the first or the second lens element (12, 14), preferably of the respective first lens (121), or second lens (141), are inserted into a corresponding groove (230) which is formed in the outer peripheral edge of the lens elements (12, 14), in particular in the first or the second lens element (12, 14), preferably in the respective first lens (121), or second lens (141).

30. The eyeglasses according to any one of claims 26 to 29, characterized in that the supporting metal wire means (16) of the lens elements (12, 14) comprise a metal wire element (16), that is, they are defined by a single metal wire element (16), which supports and surrounds the lens elements (12, 14), in particular the first and second lens elements (12, 14), preferably both the first lens (121) and the second lens (141), in particular also defining the bridge or bridge portion (163) of the eyeglasses which extends between the first and the second lens (121, 141).

31. The eyeglasses according to any one of claims 26 to 30, characterized in that means are provided for mutually fastening, in particular hooking, to opposite legs (260a, 260b) of the metal wire portion (260) which supports and surrounds the lens elements (12, 14), in particular the first and second lens elements (12, 14), preferably both the first lens (121) and the second lens (141).

32. The eyeglasses according to claim 31, characterized in that the means (262) for mutually fastening, in particular hooking, to opposite legs (260a, 260b) of the metal wire portion (260) which supports and surrounds the lens elements (12, 14) are in the form of corresponding hook means, in particular in the form of a respective hook, and preferably in the form of a first and second hook element (262, 262), each provided at the respective first and second lens element (12, 14), preferably at the respective first lens (121) and second lens (141).

33. The eyeglasses according to claim 32, characterized in that the respective hook element (262) is provided at the top of the respective first and second lens elements (12, 14), preferably at the first lens (121) and second lens (141), that is, at the centre line of the self same first and second lens elements (12, 14), that is, of the first lens (121) and second lens (141).

34. The eyeglasses according to claim 32 or 33, characterized in that the respective hook element (262) comprises a respective coil, preferably a first and a second coil (262′, 262″) of the metal wire portion (260) which supports and surrounds the lens elements (12, 14), the coils (262′, 262″) being looped round each other and, once looped, extending towards laterally opposite directions of the eyeglasses or of the respective lens.

35. The eyeglasses according to claim 34, characterized in that the respective coil has an angular extension of 180°, or substantially 180°, that is, it defines legs (e, e′) leading out of the hook (262) and extending towards the, or in the same direction as, the corresponding leg (i, i′) leading into the self same hook (262).

36. The eyeglasses according to any one of claims 32 to 35, characterized in that the respective hook element (262) is detached, in particular at the top, from the respective edge (141′), in particular top edge, of the lens elements (12, 14), in particular of the first or second lens elements (12, 14), that is, of the respective first lens (121) or second lens (141).

37. The eyeglasses according to any one of claims 34 to 36, characterized in that the first and second coils (262′, 262″) of the metal wire portion (260) engage each other at a point which is detached, in particular detached at the top, from the respective edge (141′), in particular from the top thereof, of the lens elements (12, 14), that is, of the first or second lens element (12, 14), that is, of the respective first lens (121) or second lens (141).

38. The eyeglasses according to any one of claims 32 to 37, characterized in that the leg (e) of the eyeglasses which leads out of the hook element (262) and extends towards the central part of the eyeglasses defines the bridge, or bridge portion, (163) of the self same eyeglasses.

39. The eyeglasses according to any one of claims 32 to 38, characterized in that the leg (e′) of the metal wire portion (260) which leads out of the hook element (262) and extends towards the lateral part of the eyeglasses goes to make up a lateral front portion (F) of the frame or the respective sidepiece (18, 20) of the eyeglasses.

40. The eyeglasses according to any one of claims 26 to 38, characterized in that the element, or single metal wire element (16), defines the mutual fastening means, or the respective hook element (262, 262), that is, the respective coils (262′, 262″) of the hook.

41. The eyeglasses according to any one of the preceding claims or according to the preamble to claim 1, characterized in that the supporting metal wire means (16) of the lens elements (12, 14) are defined by a single metal wire element (16) which extends to define the sidepiece or sidepieces (18, 20), in particular the entire sidepiece or sidepieces of the eyeglasses, and especially the front part (161, 162, 163) of the self same supporting metal wire means (16).

42. The eyeglasses according to claim 41, characterized in that the supporting metal wire means (16) of the lens elements (12, 14), defined by a single metal wire element (16) which extends to define the sidepiece or sidepieces of the eyeglasses, support and surround the lens elements (12, 14), in particular the first and second lens elements (12, 14), preferably the first lens (121) and the second lens (141).

43. The eyeglasses according to claim 41 or 42, characterized in that the supporting metal wire means (16) of the lens elements (12, 14), in particular defined by a single metal wire element (16), extend to define a wide, curved portion (368, 368) defining flexible articulations which extend into the respective main sidepiece portions, in particular with a linear or substantially linear shape, (18′, 20′) and which, at rest, preferably converge on each other.

44. The eyeglasses according to any one of claims 41 to 43, characterized in that the supporting metal wire means (16) of the lens elements (12, 14), that is, the single metal wire element (16), define the front part (161, 162, 163) of the self same supporting metal wire means (16) from a respective lateral end of which there extends the wide, curved portion (368, 368) defining a flexible articulation which extends into the respective main sidepiece portion.

45. The eyeglasses according to any one of claims 41 to 44, characterized in that the wide, curved sidepiece portion (368, 368), defining a flexible articulation which extends into the respective main sidepiece portion, is convex laterally of the eyeglasses.

46. The eyeglasses according to any one of claims 41 to 45, characterized in that the wide, curved flexible articulation portion (368, 368) connects the respective main sidepiece portion (18′, 20′) and the corresponding lateral portions of the front part (161, 162, 163) of the self same supporting metal wire means (16) make an angle of less than 90° with each other.

47. The eyeglasses according to any one of claims 41 to 46 or according to the preamble to claim 1, characterized in that the sidepiece portion (18′, 20′) extends to define the element (18″, 20″) for engaging the wearer's ear and is preferably in the form of means which, in use, are looped round the wearer's ear.

48. The eyeglasses according to any one of the preceding claims or according to the preamble to claim 1, characterized in that the entire frame (16) which supports the lens elements (12, 14) is defined by a single metal wire element (16).

49. A method for making eyeglasses (10) comprising lens elements (12, 14), in particular comprising a first and a second lens (121, 141), adapted to be placed in front of the wearer's eyes, and means (16) for supporting the lens elements (12, 14), characterized in that the means for supporting the lens elements (12, 14) are made using metal wire means (16) from which the lens elements (12, 14) are hung.

50. The method according to claim 49, characterized in that the means for supporting the lens elements (12, 14) are made using elastically flexible means.

51. The method according to claim 49 or 50, characterized in that the means for supporting the lens elements (12, 14) are made using a single metal wire element (16).

52. The method according to any one of claims 49 to 51, characterized in that it comprises one or more of the following steps, preferably in succession:
- inserting the suitably folded metal wire (16) into the holes (13, 13) made in the lens elements 12, in particular in the frame piece (120) thereof, the metal wire (16) having, at this stage, a portion (173) which is adapted to define part of the means (17) for fastening the lens elements (12), there being two legs (16′) and (16′″) of the metal wire extending parallel to each other from the portion (173) and adapted to respectively define the bridge element (163), the part of the respective bend (161), adjacent thereto, which supports the same lens elements 12 and the entire further bend (162) which supports the other lens elements 14, the leg (16″), on the other hand, being in turn adapted to define the remaining, transversely outermost part of the respective bend (161) which supports the lens elements 12, including the respective fastening hinge portion (164);
bending the leg (16″) of the metal wire (16) by 90° in such a way as to make it parallel to the plane defined by the lens element 12;
inserting the leg (16′) of the metal wire (16) into a hole (13) of the other lens element (14);
in turn bending the leg (16′) in such a way as to define a third leg (16′″) which extends from a further portion (173) adapted to define part of the fastening means (17) for the other lens elements (14), the third leg (16″') being inserted into the other hole (13) of the other lens elements (14);
positioning parallel to the respective lens elements (14) the third leg (16′″) which is adapted to define the outermost part of the respective bend (162) and the corresponding hinge (165) for articulated fastening of the respective sidepiece;
positioning the lens elements (12) and (14) parallel to the intermediate leg (16′);
bending the intermediate leg (16′) in such a way as to define the bridge portion (163) and the inner parts of the respective bends (161, 162) supporting the lens elements (12) and (14);
fitting the blocks (180, 200) which define part of the sidepieces of the eyeglasses to the outer legs (16″) and (16′″) which are inserted into the holes (191, 191) for the pins (231) of the sidepiece articulation hinges;
making a double 90° bend in the portions (16″) and (16′″) which are on the outer side of each sidepiece block (180, 200) to form portions (116, 116) having the general shape of a “C” with asymmetrical stretches;
bringing the blocks (180, 200) into abutment against the respective perpendicular leg of the portion (116) which extends directly from the main portion parallel to the respective lens elements (12,14) of the respective leg (16″, 16′″);
bending an end portion (116′, 116′) of the portions (116, 116) around the respective leg (16″, 16′″), which is immediately upstream, or on the inside, of the respective sidepiece block (180, 200);
rotating the blocks (180, 200) by 90° in such a way as to position them below the legs (16″) and (16′″) and thus to define the articulated connection of the respective sidepiece to the supporting metal wire element (16);
bending downwards the portions of the legs (16″) and (16′″) between the respective fastenings (17) for the corresponding lens elements (12, 14) and the sidepiece blocks (180, 200), in such a way as to define the outermost portion of the respective bend (161, 162) for supporting the respective lens elements.

53. A case (600) for holding eyeglasses (500), comprising a containing body (601) defining a chamber (602) for receiving the eyeglasses and having an opening (603) for putting the eyeglasses into, and taking them out of, the receiving chamber, the case further comprising a lid (604) which is connected in articulated fashion to the containing body (601) and which is movable between an open position for taking the eyeglasses out of, and/or putting them into, the case and a closed position where the receiving chamber is closed, characterized in that the containing body (601) is provided with means (605) for engaging and retaining a corresponding part of the eyeglasses, in particular for a respective sidepiece of the eyeglasses, preferably for both of the sidepieces (18, 20) of the eyeglasses.

54. The case according to claim 53, characterized in that when the eyeglasses are at rest inside the receiving chamber of the case, the corresponding part of the eyeglasses, in particular the respective sidepiece, preferably each of the sidepieces (18, 20) are elastically pressed against the engagement and retaining means (605).

55. The case according to claim 53 or 54, characterized in that the containing body (601) of the case has a respective surface (606) on which the eyeglasses (500) are rested.

56. The case according to any of the previous claims 53 to 55, characterized in that the engagement and retaining means are in the form of means (605) which protrude from a corresponding surface (606), preferably inside the body (601) of the case, the surface (606) preferably being the surface which supports the eyeglasses when they are at rest.

57. The case according to any one of claims 53 to 56, characterized in that the engagement and retaining means (605) are in the form of means which are open on one side to insertably receive the corresponding part of the eyeglasses, in particular a respective sidepiece, preferably both of the sidepieces (18, 20) of the eyeglasses.

58. The case according to any one of claims 53 to 57, characterized in that the engagement and retaining means (605) are open towards a corresponding wall, in particular a rear wall, (608) of the containing body (601) against which the eyeglasses (500) are rested.

59. The case according to any one of claims 53 to 58, characterized in that the engagement and retaining means (605) are located at the lid (604), in particular, at the front wall (614) of the self same lid, and preferably in proximity to the edge (609) by which lid (604) is articulated to the containing body (601); the engagement and retaining means (605) preferably rotating with the respective wall (614) of the lid (604) in such a way as to hold the corresponding part of the eyeglasses against the supporting surface (606) thereof.

60. The case according to any one of claims 53 to 59, characterized in that the engagement and retaining means (605) are in the form of an elongate element which is preferably inclined at an angle to the supporting surface (606) for resting the eyeglasses.

61. The case according to any one of claims 53 to 60, characterized in that the part of the case defining the housing for the eyeglasses, or containing body (601), comprises, in a condition for use, a bottom wall (610), in particular defining the eyeglass supporting surface (606), and/or opposite lateral walls (611, 612) which extend, preferably perpendicularly, from the lateral edges of the bottom wall (610) and/or a rear wall (608) for engaging the eyeglasses when they are held inside the case, the rear wall (608) extending, preferably perpendicularly, from the end side, in particular the long end side, of the bottom wall (610) and/or possibly a top wall (613), preferably shorter than the lateral walls (611, 612) and/or the bottom wall (610), the top wall (613), if present, extending from the rear wall (608), in particular lying parallel or substantially parallel to the bottom wall (610).

62. The case according to any one of claims 53 to 61, characterized in that the part of the case defining the lid (604) which closes the housing comprises an end wall (614) which is articulated, in particular along the long side, to the bottom wall (610) of the containing body (601) with which it is aligned and coplanar when in the open condition and which, when in the closed condition extends upwards parallel or substantially parallel to the opposite rear wall (608) of the containing body (601) for engaging the eyeglasses, there being, extending in articulated fashion from the end wall (614), a second wall (615) for closing the housing which, in use, in the closed condition, defines at least part of the top or front wall of the case and, in the open condition, is preferably coplanar with the end wall (614) of the lid and/or with the bottom wall (610) of the containing body (601).

63. The case according to any one of claims 53 to 62, characterized in that the end wall (613) of the case, which defines the lid (604) for closing the housing, is articulated to the bottom wall (610) of the containing body (601) in such a way as to able to adopt a position such as to make a corresponding obtuse angle with the bottom wall (610) of the containing body (601), in particular so as to allow quickly and automatically releasing the respective part, preferably the sidepiece, or the first and second sidepieces of the eyeglasses, elastically from the corresponding engagement and retaining means (605).

64. The eyeglasses, method and case characterized respectively in that they are as in any of the preceding claims and/or as described and illustrated in particular with reference to the accompanying drawings.
